(19) United States
(12) Patent Application Publication
(10) Pub. No.: US 2026/0334465 A1
(43) Pub. Date: Oct. 29, 2026

(54) NANOSCALE MATERIALS FOR SEED PRIMING

(71) Applicant: University of Massachusetts, Westborough, MA (US)

(72) Inventors: Om Parkash Dhankher, Amherst, MA (US); M. S. Amritha, Thenhipalam (IN); Jos Puthur, Thenhipalam (IN); Kishore Sridharan, Thenhipalam (IN)

(21) Appl. No.: 19/659,991

(22) Filed: Apr. 27, 2026

Related U.S. Application Data
(60) Provisional application No. 63/794,819, filed on Apr. 25, 2025.

(51) Int. Cl. A01N 25/08; A01P 21/00

(52) U.S. Cl. CPC A01N 25/08; A01P 21/00

(57) ABSTRACT

Disclosed are seed treatment compositions including a seed coated with graphitic carbon nitride nanosheets and methods for making and using such compositions. In some examples, urea is loaded into a crucible, optionally combined with a metal precursor, and heated to form g-C3N4 powder or metal-doped g-C3N4 powder. The powder can be washed, vacuum dried, dispersed in deionized water, and contacted with surface-sterilized seeds under agitation to prime the seeds and form a nanosheet coating. Also disclosed are primed seeds bearing the graphitic carbon nitride nanosheet coating. In rice, priming with g-C3N4 and Fe/g-C3N4 improved germination, shoot and root growth, chlorophyll and carotenoid content, and reduced arsenic translocation under drought stress and arsenic stress. The primed seeds further exhibited enhanced nutritional value, including increased levels of Zn, Fe, Mg, and K, and increased seed yield under drought and salinity stresses at maturity in treated plants at later stages of development.

### CROSS REFERENCE TO RELATED APPLICATION

The present application claims the benefit of priority to U.S. Provisional Application No. 63/794,819, filed Apr. 25, 2025, the content of which is incorporated in its entirety herein.

### STATEMENT REGARDING FEDERALLY SPONSORED RESEARCH

This disclosure was made possible through partial unrestricted funds by the University of Massachusetts Amherst and partial financial assistance provided by Council of Scientific and Industrial Research (CSIR), Government of India under the Fund for Improvement of S&T Infrastructure (FIST) program (SR/FST/LSI-532/2012). Further support was provided by DST-Science and Engineering Research Board (DST-SERB) Government of India for granting funds under SUR grant (SUR/2022/002538-G).

### TECHNICAL FIELD

The present disclosure relates generally to the usage of nanoscale materials for the purpose of priming seeds. The present disclosure discusses seed priming with graphitic carbon nitride (g-C₃N₄; 250 μg/L) and iron-doped graphitic carbon nitride (Fe/g-C₃N₄; 250 μg/L) and zinc-doped graphitic carbon nitride (Ze/g-C₃N₄; 250 μg/L) nanosheets synthesized through a facile single-step pyrolysis approach. The effect of the priming on plant response to abiotic stresses including drought, salinity, and toxic metals and biofortification of iron in grains/seeds is demonstrated. Improved nutrient accumulation and crop performance is further demonstrated.

### BACKGROUND

Extreme abiotic stresses, such as drought, high and low temperatures, metal toxicity, and soil salinity, significantly hinder plant growth and productivity, thereby jeopardizing global food security. Climate change exacerbates this by making plant growth more vulnerable to changes in precipitation and temperature. Over the last few decades, extended drought and the slow accumulation of heavy metals in the bioactive layers of soils have emerged as two major concerns affecting crop productivity, human health, and global food security.

Rice is a crucial food source for billions. Alterations in soil conditions markedly impact rice growth, intensifying existing problems associated with rice production. Drought, salinity, and toxic metals such as arsenic and cadmium contamination are recognized impediments to rice cultivation. These pressures interfere with physiological processes, causing inadequate water and nutrient availability and diminishing photosynthetic efficiency, which ultimately reduces crop yield and quality. Rice plants exhibit intrinsic adaptive responses to withstand abiotic challenges; nevertheless, drought, salinity, and toxic metal stress can significantly hinder the adaptive response mechanisms, resulting in irreversible cellular and metabolic damage. In the face of rising populations and looming food scarcity, confronting overcoming these problems is essential.

To mitigate the negative effects of abiotic stressors, various strategies have been employed, ranging from classical approaches (e.g., plant breeding, planting time optimization, enhanced harvesting techniques, etc.) to very complex genetic engineering. However, these solutions typically demand a significant cost and labor, impeding practical adoption, particularly among farmers with limited resources. Seed priming is a popular and cost-effective method which involves the pretreatment of seeds with natural or synthetic chemicals to trigger physiological changes that enhance stress tolerance. Despite being the most successful of the many techniques, chemical priming has drawbacks of its own.

Traditional chemical priming can present several disadvantages related to seed size variability. In large, heterogeneous seed batches, smaller seeds may absorb a chemical treatment more rapidly than larger seeds, which can cause some seeds to germinate prematurely during treatment and thereby produce irregular crop stands instead of more uniform establishment. Standardization of the priming procedure can also be difficult since an appropriate priming duration may depend on seed size and seed maturity, such that a single treatment protocol may not be optimal for all seeds in a batch and may reduce germination rates if not properly controlled. Primed seeds may also exhibit reduced shelf life, and this issue can be exacerbated when the treatment substantially alters seed size or moisture content, thereby making redrying and storage more difficult. In addition, when smaller seeds are exposed to the same treatment duration as larger seeds, the smaller seeds may advance to phase III of germination, including radicle protrusion, during treatment and may be damaged during subsequent drying or handling as a result.

Chemical priming with nanoparticle-based technologies promises to be much more efficient and affordable due to the small size of the applied nanoparticles and associated ease of plant absorption,.

Nanoparticles, ranging from 1 to 100 nanometers, possess sophisticated delivery systems and exhibit notable morphological characteristics applied across various domains of plant-based research. These properties enable plants to endure drought, metal toxicity, and various environmental challenges by promoting uniform germination and establishment of seedlings, as well as enhancing antioxidant enzyme activity, which reduces oxidative stress and increases plant resilience. Currently various researchers are interested and investigating the potential applications of nanoparticle mediated seed priming, which could substantially influence sustainable agriculture and global food security in the context of climate change.

The application of various nanomaterials in seed priming demonstrates significant potential for enhancing plant resilience to drought and toxic metals stress. Prior research demonstrated that multi-walled carbon nanotubes (MWCNTs) promote the growth of pollen-alder roots and enhance the drought resistance of Alnus subcordata (Caucasian alder). Calcium chloride and hydroxyapatite nanoparticles (nHA) treatment increases the drought resistance of jute seeds by increasing the proline biosynthesis, which helps the seeds adjust to changes in osmotic pressure. Also, adding zinc oxide nanoparticles (ZnO NPs) to soybean seeds raised the amounts of plant growth regulators (PGRs) like gibberellins and auxins. Studies have also found that silica nanoparticles helped wheat seedlings to reduce Cd toxicity by increasing antioxidant enzymes and lowering the production of reactive oxygen species (ROS). Silica nanoparticles also inhibited cadmium uptake and accumulation in plants. Zn and Fe nanoparticles effectively reduced Cd contamination in wheat to permissible levels safer to humans while simultaneously promoting plant growth. The findings highlight the varied applications of nanomaterials in improving plant performance in response to abiotic stresses.

Seed priming with nanoscale materials is clearly a promising strategy in agricultural science, having the potential to improve plant growth under a wide range of challenging circumstances. Even though there is more interest, not much is known about how to develop and use nanomaterials that are safe for the environment as seed priming agents to improve abiotic stress tolerance. There is a definite need for the development of such nanomaterials in the face of a harsher climate and higher crop production demands. Graphitic carbon nitride (g-C₃N₄) is one such substance derived from urea, used as fertilizer. Several researchers have investigated the efficacy of urea treatment in reducing drought and heavy metal stress in crops. Urea has shown promise for improving antioxidant defense mechanisms and osmotic adjustment in crops like maize and rice, thereby decreasing the negative impacts of drought stress. However, studies have demonstrated that using urea as a fertilizer increases the uptake of heavy metals in plants. In contrast, the nanoform g-C₃N₄ appears to reduce heavy metal pollutants in rice, including cadmium and arsenic. However, the there is no evidence of its usefulness in combating drought stress. Further, the iron-doped graphitic carbon nitride (Fe/g-C₃N₄) and zinc-doped graphitic carbon nitride (Zn/g-C₃N₄) showed much higher tolerance to drought and salinity, respectively, than the undoped nascent g-C₃N₄.

Similarly, iron in both bulk and nano form has numerous biological and agricultural applications. Fe NPs in agriculture have the potential to alleviate Fe shortage in various crops, and the studies have demonstrated their ability to reduce drought and heavy metal stress in crops. Iron oxide nanoparticles (Fe NPs) boosted wheat growth and photosynthesis while decreasing oxidative stress during Cd and drought stress. Studies further indicate that iron nanoparticle treatment regulated the CREB cycle by regulating succinate dehydrogenase and made canola more resistant to drought. Also, iron oxide (Fe₂O₃) nanoparticles lower the stress that drought caused in grape plants by enhancing the antioxidants in the leaves. There have also been findings that iron nanoparticles protect against heavy metal stress, particularly in rice, by enhancing oxidative tolerance and reducing Pb uptake report that iron oxide nanoparticles reduce arsenic phytotoxicity in rice by enhancing iron uptake, increasing oxidative stress tolerance, and reducing arsenic buildup.

Despite the above leads, and in view of the inherent lack of clear predictability in the field, there remains a need for priming agents suitable for mitigating drought and heavy metal stress in rice.

### SUMMARY

Graphitic carbon nitride (g-C₃N₄; 250 μg L⁻¹) and Iron-doped graphitic carbon nitride (Fe/g-C₃N₄; 250 μg L⁻¹) nanosheets synthesized through a facile single-step pyrolysis approach were employed as priming agents for alleviating PEG-induced drought stress (15%) and arsenic (As III, 10 ppm) induced metal stress in rice (Oryza sativa L). X-ray diffraction and electron microscopy studies confirmed the formation of g-C₃N₄ with sheet-like morphology and the doping of Fe on g-C₃N₄. Seed priming with Fe/g-C₃N₄ significantly enhanced germination, shoot/root lengths, and fresh/dry weights under drought and arsenic stress compared to g-C₃N₄ and control unexposed plants. Improved chlorophyll and carotenoid levels, along with enhanced Chl a fluorescence, underscore the efficacy of Fe/g-C₃N₄ priming in enhancing the photosynthetic efficiency under drought stress. Furthermore, priming with Fe/g-C₃N₄ led to a significant reduction in malondialdehyde, hydrogen peroxide, and superoxide contents in the shoots. It also increased antioxidant and metabolite accumulation such as ascorbate, glutathione, flavonoids, and anthocyanins, contributing to enhanced plant tolerance to drought stress. The seed priming process with g-C₃N₄ and Fe/g-C₃N₄ not only resulted in an enhancement of growth parameters but also decreased arsenic translocation in rice. The Fe/g-C₃N₄ showed superiority over the g-C₃N₄ as the results were more promising with Fe/g-C₃N₄. These findings highlight the potential of Fe/g-C₃N₄ nanosheets as excellent seed-priming agents for mitigating drought induced and heavy metal induced stress and for improving climate resiliency in rice for enhanced food security.

In one aspect, seed treatment materials and related methods are provided that employ graphitic carbon nitride nanosheets in association with seeds. A seed can be provided with a graphitic carbon nitride nanosheet coating, which in some embodiments may include one or more positive ions or metals. Suitable ions or metals may include one or more of Zn, Ca, Cu, Fe, B, Mn, Mo, Ni, and S. The disclosed materials may be used with crop plant seeds and may be used alone or in combination with one or more additional seed coatings, including moisture control coatings, antifungal coatings, insecticidal coatings, fertilizer coatings, or combinations thereof.

In another aspect, graphitic carbon nitride nanomaterials may be prepared from a nitrogen-containing precursor under heating conditions effective to form graphitic carbon nitride powder. In some embodiments, a metal precursor may be included so as to provide a doped graphitic carbon nitride material. The resulting material may be washed and dried and then dispersed in water or another suitable medium for application to seeds.

In a further aspect, seeds may be contacted with a dispersion containing graphitic carbon nitride nanosheets for a period sufficient to prime the seeds and form a coating on the seed surface. The treated seeds may thereafter be removed from the dispersion and dried for storage, handling, or planting. In some embodiments, the disclosed treatment provides a primed seed having a graphitic carbon nitride nanosheet coating, optionally in combination with one or more additional seed treatment layers.

In another aspect, methods are provided for improving abiotic stress tolerance in plants. A seed may be contacted with a dispersion comprising graphitic carbon nitride nanosheets under conditions effective to form a graphitic carbon nitride nanosheet coating on the seed. The treated seed may then be planted and grown to produce a plant exhibiting improved tolerance to one or more abiotic stresses, including drought stress, salinity stress, and toxic metal stress. In some embodiments, plants grown from the treated seeds exhibit increased productivity under drought stress or salinity stress relative to plants grown from untreated seeds. In some embodiments, the plant is rice.

In a further aspect, methods are provided for biofortifying crop plants. A seed may be contacted with a dispersion comprising graphitic carbon nitride nanosheets doped with one or more micronutrient elements and then planted and grown to produce a plant having increased accumulation of one or more nutrient elements in harvested plant material. In some embodiments, the one or more micronutrient elements include Zn, Fe, Ca, Cu, B, Mn, Mo, Ni, or S.

### BRIEF DESCRIPTION OF THE DRAWINGS

The file of this patent contains at least one drawing/photograph executed in color. Copies of this patent with color drawing(s)/photograph(s) will be provided by the Office upon request and payment of the necessary fee.

The accompanying drawings, which are incorporated into and form a part of the specification, illustrate several embodiments of the present disclosure; and, together with the description, serve to explain the principles of the disclosure. The drawings are only for the purpose of illustrating an embodiment of the invention and are not to be construed as limiting the disclosure. Further objects, features and advantages of the disclosure will become apparent from the following detailed description taken in conjunction with the accompanying figures showing illustrative embodiments of the invention, in which:

FIGS. 1A, 1B, and 1C present three different TEM micrographs of g-C₃N₄ at different magnifications. The inset of FIG. 1C presents an SAED pattern. FIG. 1D presents an HRTEM micrograph. FIG. 1E presents an EDS.

FIGS. 2A, 2B, and 2C present TEM micrographs of Fe/g-C₃N₄ at different magnifications. The inset of FIG. 2C presents an SAED pattern. FIG. 2D presents an HRTEM micrograph. FIG. 2E presents an EDS.

FIGS. 3A-3F represent the phenotypes of primed and unprimed rice seedlings in treated and non-treated conditions. FIG. 3G represents a single plantlet from primed and unprimed seeds under treated and control conditions. FIG. 3H presents the germination percentages of rice seeds in treated and non-treated conditions. FIG. 3I presents shoot and root lengths of rice seedlings in treatment and control conditions. FIGS. 3J and 3K illustrate respective fresh and dry weights of roots and shoots in treated and non-treated conditions.

FIG. 4A presents chlorophyll data and FIG. 4B presents carotenoid content for control and treatment conditions. FIG. 4C presents maximum quantum yield of PS II and FIG. 4D represents electron transport flux of PS II for control and treatment conditions.

FIG. 5A represents malondialdehyde content in roots and shoots, FIG. 5B, and 5C represent hydrogen peroxide content estimated quantitively and confirmed through H2DCFDA staining in roots and shoots of treated and control seedlings.

FIG. 6A represents proline content in roots and shoots, FIGS. 6B and 6C respectively present superoxide content and presence of superoxide confirmed through NBT staining in control and treated seedlings.

FIGS. 7A and 7B present root and shoot anthocyanin as well as flavonoid content in treated and control conditions. FIGS. 7C and 7D present root and shoot ascorbate and glutathione content in treated and control conditions.

FIGS. 8A, 8B, 8C, 8D and 8E respectively present the changes in the accumulation of essential elements iron, magnesium, potassium, sulfur and zinc in seedlings developed from primed and unprimed seeds grown under the presence and absence of drought stress induced by PEG.

FIGS. 9A-9F present the phenotypes of seedlings grown from primed and unprimed rice seeds with and without As III stress. FIG. 9G presents the fresh weight, FIG. 9H represents dry weight and FIG. 9I represents length of shoot and roots of the rice seedlings in treatment and control conditions.

FIGS. 10A-10F present plantlets from primed and unprimed seeds under the presence and absence of As III. FIGS. 10G and 10H illustrate As III accumulated in shoots and roots respectively. FIG. 10I presents respective root to shoot translocation ratio/factor for As III (TF) in plantlets germinated and grown from primed and unprimed seeds under the presence and absence of As III.

FIG. 11 presents seed data for seed yield at maturity in rice plants grown from seed primed with g-C₃N₄, Zn/g-C₃N₄, and Fe/g-C₃N₄. FIG. 11A presents 100-grain weight, FIG. 11B presents number of chaffy and filled grain in a plant, FIG. 11C presents filled grain yield per panicle for control, g-C₃N₄, Zn/g-C₃N₄, and Fe/g-C₃N₄, primed plants, respectively and FIG. 11D presents harvest index for control, g-C₃N₄, Zn/g-C₃N₄, and Fe/g-C₃N₄, primed plants, respectively.

FIG. 12 presents the improved nutritional quality of rice seeds of rice plants primed with g-C₃N₄, Zn/g-C₃N₄, and Fe/g-C₃N₄. FIG. 12A presents sugar content, FIG. 12B presents total protein, FIG. 12C presents starch, and FIG. 12D presents amino acids extracted from the grains obtained from control as well as g-C₃N₄, Zo/g-C₃N₄, and Fe/g-C₃N₄, primed plants, respectively.

FIG. 13 presents Zn and Fe biofortification of rice grains. FIG. 13A presents zinc content and FIG. 13B presents iron content in the grains obtained from control as well as g-C₃N₄, Zn/g-C₃N₄, and Fe/g-C₃N₄, primed plants, respectively.

FIG. 14A illustrates the phenotypic alterations of 95-day old rice plants following a two-week exposure to drought stress. Panels (14B-14D) illustrate the alterations in gas exchange parameters of 95-day-old rice plants, with (14B) representing intercellular CO₂ concentration, (14C) and (14D) representing stomatal conductance and net photosynthetic rate respectively.

FIG. 15A illustrates the heatmap of various yield parameters studied upon maturity. Panels (15B) illustrate the total seed yield per plant (15C) representing 100 grain weight, (15D) and (15E) representing harvest index and number of filled and chaffy grains in 125-day old, matured plants.

FIG. 16A illustrates the phenotypic alterations of 95-day old rice plants following a two-week exposure to NaCl stress. Panels (16B-16D) illustrate the alterations in gas exchange parameters of 95-day-old rice plants, with (16B) representing intercellular CO₂ concentration, (16C) and (16D) representing stomatal conductance and net photosynthetic rate respectively.

FIG. 17A illustrates the heatmap of various yield parameters studied upon maturity. Panels (17B) illustrate the total seed yield per plant (17C) representing 100 grain weight, 17(D) and (17E) representing harvest index and number of filled and chaffy grains in 125-day old, matured plants.

FIG. 18 illustrates XRD patterns for g-C₃N₄ and Fe/g-C₃N₄.

FIG. 19 Presents characterization data of Zn/g-C₃N₄ nanosheet. FIGS. 19A, 19B, 19C, and 19D are TEM images. FIG. 19E is an EDX analysis of Zn/g-C₃N₄ nanosheets.

FIGS. 20A-D illustrate the variations in seedling length, MDA content, fresh weight, and dry weight of seedlings subjected to 0%, 5%, 10%, 15%, 20%, and 25% PEG.

FIGS. 21A-D illustrate the variations in seedling length, MDA content, fresh weight, and dry weight of seedlings grown from seeds primed with 50 and 250 μg/L g-C₃N₄ and Fe/g-C₃N₄, under conditions of 15% PEG stress and without the stress.

FIGS. 22A-D illustrate the variations in essential element distribution of the seedlings grown from seeds primed with 250 μg/L g-C₃N₄ and Fe/g-C₃N₄, under conditions of 15% PEG stress and without the stress.

FIGS. 23A-B illustrate the variations in essential element distribution of the seedlings grown from seeds primed with 250 μg/L g-C₃N₄ and Fe/g-C₃N₄, under conditions of 10 ppm As III stress and without the stress.

### DETAILED DESCRIPTION

### Terminology

Unless defined otherwise, all technical and scientific terms used herein have the same meaning as is commonly understood by one of skill in the art to which the claimed subject matter belongs. It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

The transitional phrases “comprising” and “having” are open-ended and may include other, not explicitly recited, elements. An element or a plurality of elements having a particular property may include additional such elements not having that property.

As used herein the concept of “priming” or “seed priming” refers to a process that can regulate germination of a seed by the improvement of metabolic processes. Priming may be done by both physical or chemical means. In some instances a physical process, such as the application of a coating to a seed, may effect further chemical or biochemical changes in the seed and resulting roots and shoots.

Embodiments disclosed with an open-ended transitional phrase such as “comprising” include, as alternative embodiments, embodiments recited with the same elements but with an intermediate or closed transitional phrase such as “consisting essentially of” or “consisting of.” As used herein, ranges and amounts can be expressed as “about” a particular value or range. About also includes the exact amount. Hence “about 5 μL” means “about 5 μL” and also “5 μL.” Generally, the term “about” includes an amount that would be expected to be within experimental error or within the error expected from manufacturing, production, or experimental tolerances.

As used herein, the term “graphitic carbon nitride nanosheet coating” refers to a coating present on a seed and including graphitic carbon nitride nanosheets on at least a portion of a seed surface. The graphitic carbon nitride nanosheet coating may be provided as a layer, partial layer, deposited material, adhered material, associated material, or other surface-applied form resulting from contact of the seed with a dispersion, solution, suspension, or other medium containing graphitic carbon nitride nanosheets. The graphitic carbon nitride nanosheet coating may be continuous or discontinuous, may cover all or less than all of the seed surface, and may optionally include one or more dopants, one or more additional coatings, or both.

As used herein, the term “graphitic carbon nitride nanosheet” refers to a graphitic carbon nitride material having a nanoscale sheet-like morphology. In some embodiments, the graphitic carbon nitride nanosheet is a two-dimensional sheet-like graphitic carbon nitride material formed from carbon and nitrogen and capable of being dispersed in a liquid medium for contact with a seed. The graphitic carbon nitride nanosheet may be undoped or doped and may be present as an individual nanosheet, part of an aggregate, or part of a population of sheet-like particles.

As used herein, the term “g-C₃N₄ powder” refers to graphitic carbon nitride nanomaterial, wherein “g-C₃N₄” is an abbreviation for graphitic carbon nitride. Such a material is not required to be in the form of a powder (e.g., it may be a suspension, emulsion, compressed granule, etc.) though referred to here for the sake of convenience. The g-C₃N₄ powder may be obtained by heating a nitrogen-containing precursor under conditions effective to form graphitic carbon nitride and may be present as a dry particulate material suitable for washing, drying, dispersing, coating, seed treatment, or combinations thereof.

As used herein, the term “metal-doped g-C₃N₄ powder” refers to a g-C₃N₄ nanomaterial in which graphitic carbon nitride is associated with one or more metals introduced from a metal precursor during formation of the material. In similar vein to the above g-C₃N₄ powder, such a material is not required to be in the form of a powder (e.g., it may be a suspension, emulsion, compressed granule, etc.) though referred to here for the sake of convenience. The metal-doped g-C₃N₄ powder may include a metal present on, in, with, or relative to the graphitic carbon nitride structure in an amount effective to distinguish the material from undoped g-C₃N₄ powder. The metal-doped g-C₃N₄ powder may be used in dry form or after dispersion in a liquid medium.

As used herein, the term “positive ion” refers to an ion having a net positive electrical charge. In the context of the claimed subject matter, the positive ion may be associated with, incorporated into, supported on, deposited on, or otherwise provided with graphitic carbon nitride nanosheet material or a graphitic carbon nitride nanosheet coating. A positive ion may be monovalent, divalent, trivalent, or of another positive charge state.

As used herein, the term “metal precursor” refers to a starting material that supplies one or more metals for formation of a metal-doped g-C₃N₄ powder or other doped graphitic carbon nitride material. The metal precursor may be a salt, complex, compound, coordination compound, hydrate, or other metal-containing material capable of providing the metal during synthesis. The metal precursor may supply one or more elements selected for doping of the graphitic carbon nitride material.

As used herein, the term “surface-sterilized seeds” refers to seeds that have been subjected to a treatment effective to reduce, remove, inactivate, or otherwise control microorganisms present on the exterior seed surface. Surface-sterilized seeds are distinguished from untreated seeds by the performance of a surface sterilization step prior to priming, coating, soaking, or other seed treatment. Surface sterilization may be carried out with an aqueous treatment medium or another suitable sterilizing medium.

As used herein, the term “seed-solution mixture” refers to a mixture that includes seeds together with a solution containing the powder after dissolution or dispersion in deionized water. The seed-solution mixture may be maintained under agitation or other contacting conditions for a period sufficient to permit contact between the seeds and the dissolved or dispersed material. The seed-solution mixture may include only seeds and the solution, or may further include other materials suitable for seed treatment.

As used herein, the term “primed seeds” refers to seeds that have undergone priming. As used herein, priming or seed priming refers to a process that can regulate germination of a seed by the improvement of metabolic processes. The primed seeds may be seeds that have been contacted with a physical or chemical priming treatment, including a graphitic carbon nitride nanosheet-containing treatment, and may thereafter be dried, stored, handled, planted, coated, or further treated.

As used herein, the term “crop plant seed” refers to a seed of a plant cultivated or intended to be cultivated for agricultural, horticultural, nutritional, industrial, feed, fiber, propagation, or related crop production purposes. A crop plant seed may be a seed of a cereal, grain, legume, vegetable, fruit, oilseed, forage, or other agronomically relevant plant species. The term does not require any particular taxonomy, size, morphology, or growing environment unless otherwise specified.

As used herein, the term “moisture control coating” refers to a coating on a seed that is configured to influence moisture exposure, moisture transfer, moisture retention, moisture uptake, moisture release, or another moisture-related condition at the seed surface. The moisture control coating may be present as an additional coating used together with the graphitic carbon nitride nanosheet coating and may be applied as a full or partial layer.

As used herein, the term “antifungal coating” refers to a coating on a seed that includes or is configured to provide antifungal activity, antifungal protection, antifungal treatment, antifungal suppression, or another antifungal function at or near the seed surface. The antifungal coating may be present as an additional coating used together with the graphitic carbon nitride nanosheet coating and may include one or more antifungal materials.

As used herein, the term “insecticidal coating” refers to a coating on a seed that includes or is configured to provide insecticidal activity, insect control, insect suppression, insect protection, or another insect-directed function at or near the seed surface. The insecticidal coating may be present as an additional coating used together with the graphitic carbon nitride nanosheet coating and may include one or more insecticidal materials.

As used herein, the term “fertilizer coating” refers to a coating on a seed that includes or is configured to provide one or more nutrients to the seed, a germinating plant, or a plant grown from the seed. The fertilizer coating may be present as an additional coating used together with the graphitic carbon nitride nanosheet coating and may include macronutrients, micronutrients, nutrient-containing compounds, or combinations thereof.

As used herein, the term “wt %” refers to weight percent. Weight percent is a concentration expression based on the weight of a stated component relative to a total weight, multiplied by 100. Unless otherwise specified, wt % may be used to express the amount of a component in a mixture, formulation, reaction charge, precursor composition, coating composition, or other material.

### ABBREVIATIONS

The following abbreviations are used in this disclosure:
EDS energy-dispersive x-ray spectroscopy/spectrum
FESEM field emission scanning electron microscopy.
g-C₃N₄ graphitic carbon nitride
Fe/g-C₃N₄ iron-doped graphitic carbon nitride
Zn/g-C₃N₄ Zinc-doped graphitic carbon nitride
PEG poly ethylene glycol
As III arsenic
GSH glutathione
HRTEM high-resolution transmission electron microscopy
MDA malondialdehyde
ROS reactive oxygen species
SAED selected area electron diffraction
XRD x-ray Diffraction

As disclosed herein, adding iron and or zinc to the nano form of urea can increase the effectiveness of the material in helping rice adapt to the effects of drought, salinity, and heavy metals. The disclosures herein present a thorough examination of the efficacy of iron-doped nano-urea (Fe/g-C₃N₄) and zinc-doped nano-urea (Zn/g-C₃N₄) as a priming agent for mitigating drought, salinity, and heavy metal stress in rice. This research demonstrates that the synergistic effects of iron, zinc, and nano-urea have substantial implications for sustainable agriculture, providing an innovative method to improve crop resilience and address the negative effects of climate change and food security.

Among various nanoscale materials, graphitic carbon nitride (g-C₃N₄) stands out as a chemically and thermally stable organic compound formed with earth-abundant carbon and nitrogen elements, making it an environmentally friendly nanomaterial. Unlike conventional nanoparticles employed for seed-priming that might not ensure optimal surface contact with seeds, the two-dimensional (2D) sheet-like morphology of g-C₃N₄ is anticipated to envelop the seeds, maximizing surface interaction, and potentially enhancing the effectiveness. Consequently, g-C₃N₄has been reported to significantly enhance plant tolerance even in harsh environmental conditions such as exposure to toxic elements such as arsenic (As) and cadmium (Cd). However, research on their efficacy in alleviating drought stress is limited, and there are currently no reports indicating the potential role of g-C₃N₄ and Fe-doped g-C₃N₄ priming in mitigating As III stress. The present disclosure illustrates the effectiveness of g-C₃N₄ and Fe-doped g-C₃N₄ (referred hereafter as Fe/g-C₃N₄) as seed priming agents, aiming to enhance the tolerance of rice plants, and by extension other crop plants, to drought and As III stress.

Priming rice seeds with the synthesized nanosheets disclosed herein demonstrated notable enhancements in seed germination, shoot, root lengths, and overall biomass, mitigating the adverse effects of drought and As III stress. The nanosheets disclosed effectively preserved the photosynthetic apparatus, countering the negative impact on photosynthesis made by salt stress. Other features of the primed seedlings were reduced ROS generation, preventing membrane damage, indicating enhanced cellular membrane stability. Primed seedlings exhibited lower proline levels, suggesting reduced stress, accompanied by increased expression of antioxidants and secondary metabolites. Priming with g-C₃N₄ and Fe/g-C₃N₄ significantly influenced ion homeostasis by increasing iron and zinc levels, thereby facilitating biofortification with essential elements. The priming with g-C₃N₄ and Fe/g-C₃N₄ mitigated the adverse effects of As III. It restricted the transfer of As III from the root to the shoot. Thus, priming with g-C₃N₄ and Fe/g-C₃N₄ ensured dual benefits: not only boosting rice growth under drought and As III stress but also promoting environmental sustainability due to its eco-friendly nature, making it a worthwhile solution for agriculture.

### RESULTS AND DISCUSSION

### Characterization of Nanoparticles

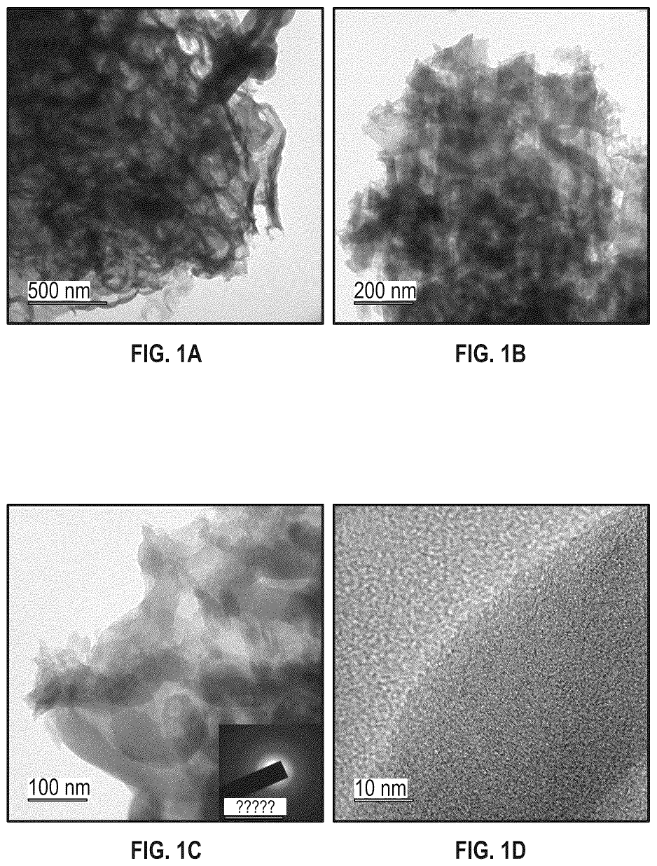

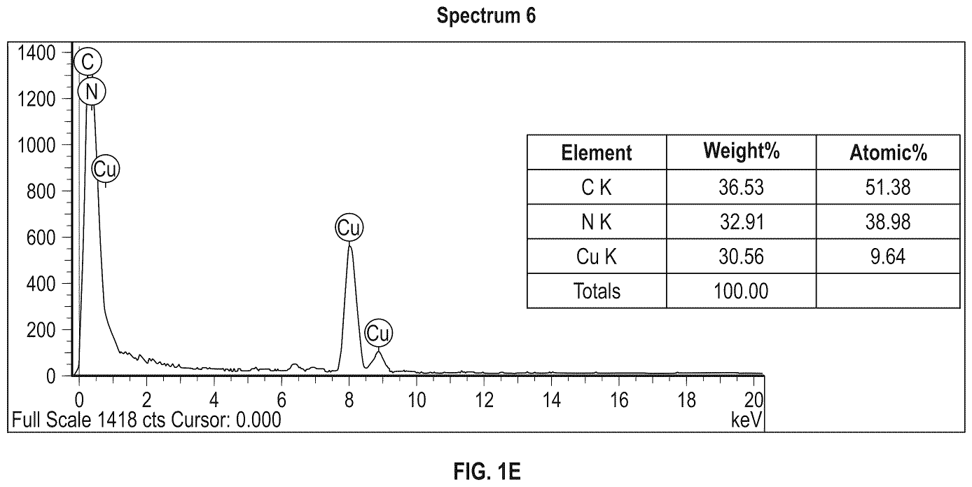

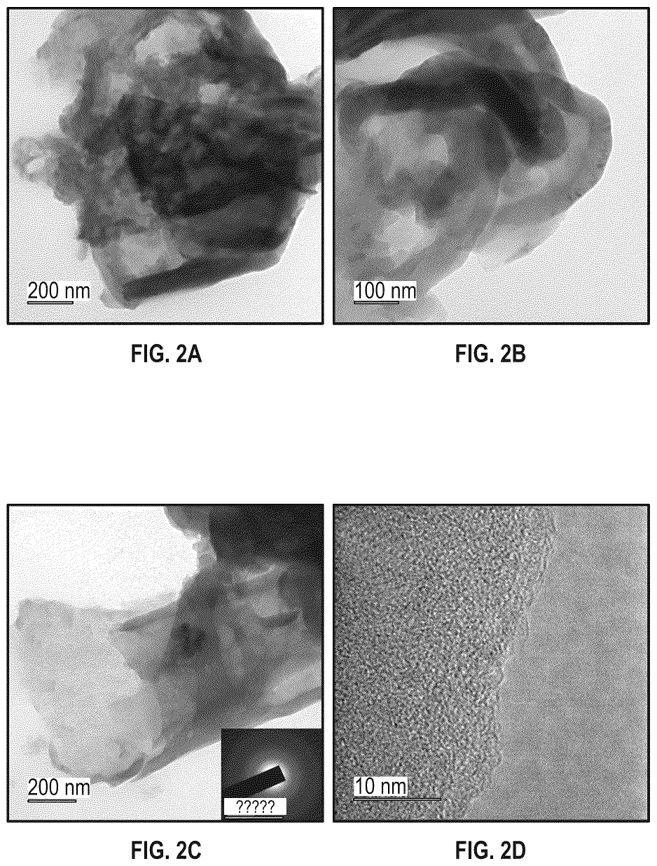

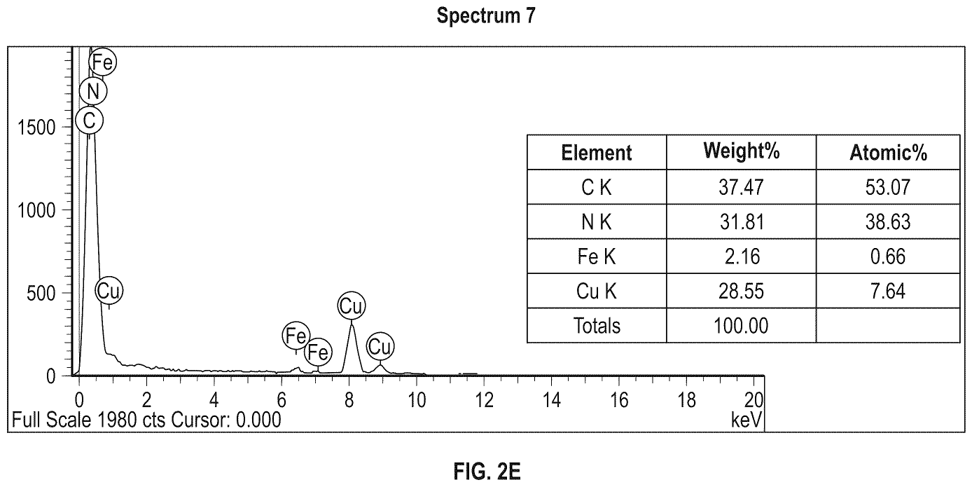

TEM micrographs of g-C₃N₄ under three different magnifications depicted in FIGS. 1A, 1B and 1C clearly reveal the two-dimensional sheet like structure analogous to graphene. Also, the curled-up nature of sheets distinctly evident from FIG. 2A could facilitate higher adsorption of some molecular species. Furthermore, the porous nature is apparent from the magnified TEM micrograph shown in FIG. 1C. XRD peak corresponding to the (002) plane of g-C₃N₄ is broader owing to its polymeric nature due to which its crystallinity is poor. Therefore, the lattice fringes corresponding to (002) plane is not clearly visible from the high-resolution TEM micrograph shown in FIG. 1D and can be observed on the edges. On the other hand, the ring type SAED pattern shown in the inset of FIG. 1C, with highly intense central ring clearly matches with the XRD data of g-C₃N₄ and the EDS (FIG. 1E) data without any additional peaks other than C, N and Cu (from the TEM grid) is indicative of its purity.

The TEM micrographs of Fe/g-C₃N₄ presented in FIGS. 2A, 2B and 2C under three different magnifications also reveals the 2D morphology of g-C₃N₄ with curled sheets. Additionally, the presence of nanoparticles corresponding Fe added as dopant are observed as dark spots on g-C₃N₄ sheets seen in FIG. 2B and FIG. 2C. However, the nanoparticles corresponding to Fe are not found to be spread all over the g-C₃N₄ sheets since the dopant concentration was minimal due to which the SAED pattern (inset of FIG. 2C) was similar to the ring diffraction pattern of g-C₃N₄. Similarly, the lattice fringes are not clearly observed in the HRTEM micrograph in FIG. 2D. On the other hand, the EDS data (FIG. 2E) reveals the presence of Fe doping and the atomic wt % is close to the amount added during the synthesis.

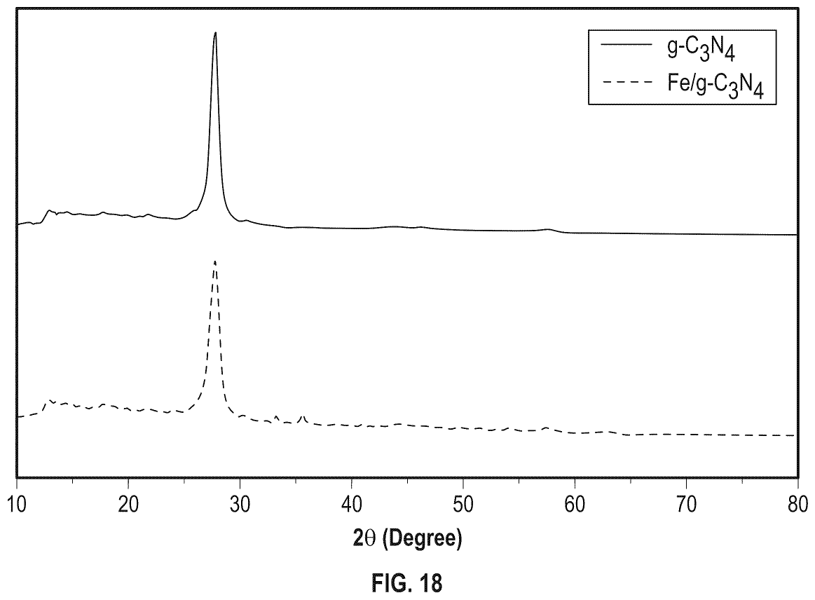

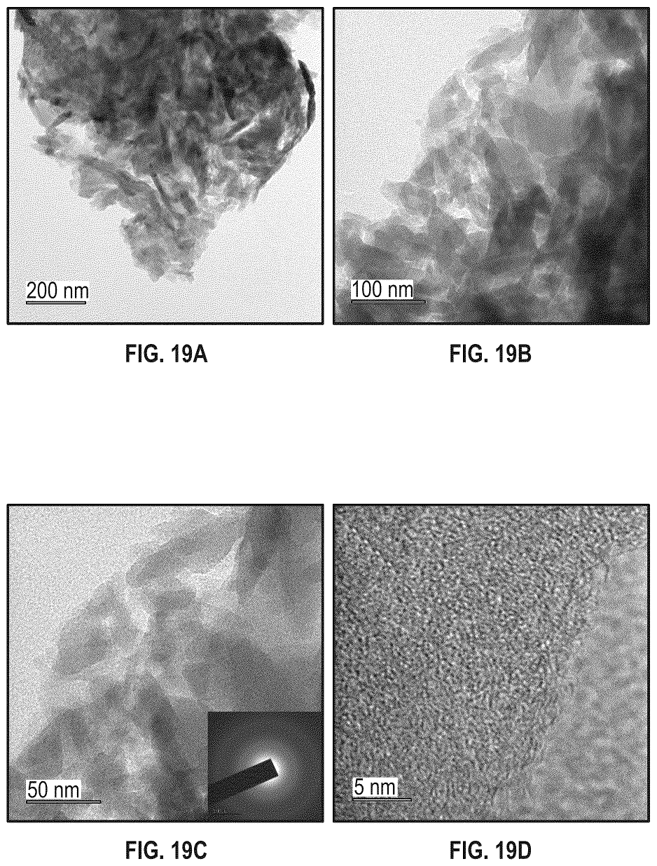

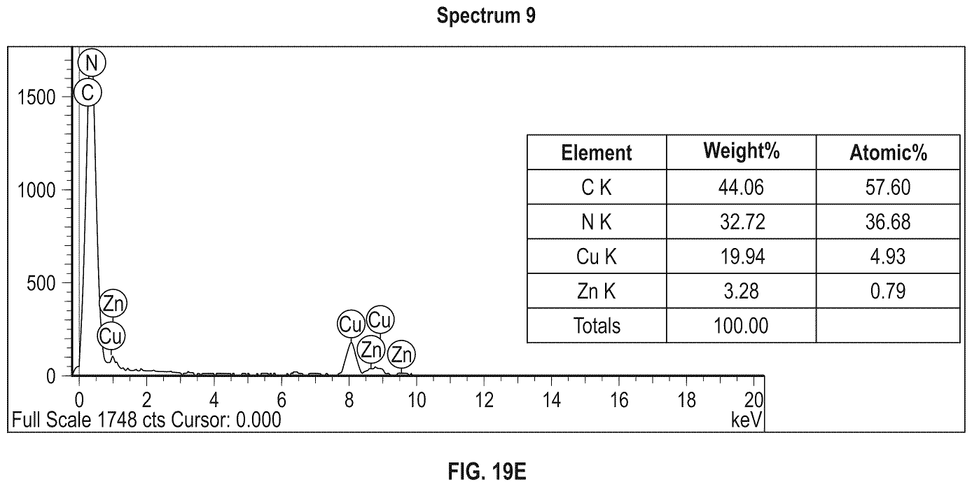

The TEM micrographs of Zn/g-C₃N₄ presented in FIGS. 19A, 19B and 19C under three different magnifications also reveals the 2D morphology of g-C₃N₄ with curled sheets. Additionally, the presence of nanoparticles corresponding Fe added as dopant are observed as dark spots on g-C₃N₄ sheets seen in FIG. 18B and FIG. 19C. However, the nanoparticles corresponding to Zn are not found to be spread all over the g-C₃N₄ sheets since the dopant concentration was minimal due to which the SAED pattern (inset of FIG. 19C) was similar to the ring diffraction pattern of g-C₃N₄. Similarly, the lattice fringes are not clearly observed in the HRTEM micrograph in FIG. 19D. On the other hand, the EDS data (FIG. 19E) reveals the presence of Zn doping and the atomic wt % is close to the amount added during the synthesis.

### Studies on Growth Biomarkers

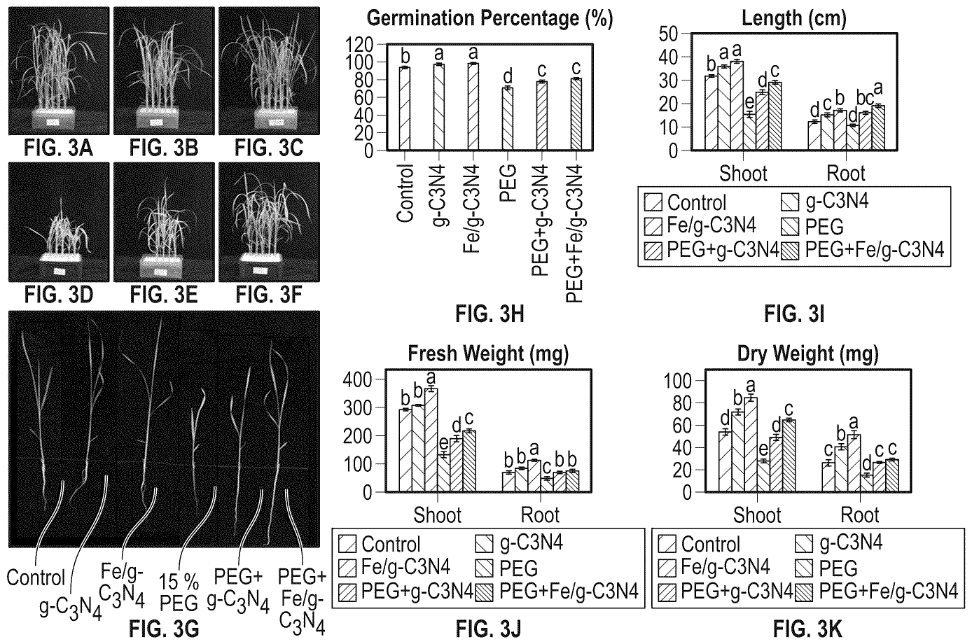

The g-C₃N₄ and Fe/g-C₃N₄ priming treatments demonstrated a substantial beneficial effect in mitigating drought stress evidenced by alterations in morphology of rice seedlings exposed to drought (FIGS. 3A-3F). The impact of stress on rice growth and the impact of priming against stress were evaluated by analysing a variety of growth metrics, including fresh and dry weight, shoot and root length, and germination percentage (GP). The limited water availability to the seeds caused by drought stress induced by PEG negatively affects seed germination rates and hinders seedling growth in rice. The germination rates of rice seedlings demonstrated a significant impact from priming and drought stress induced by 15% PEG, with germination percentage (GP) drastically reduced to 25% under drought conditions, highlighting the adverse effect on seedling growth. On the other hand, under drought stress conditions, priming g-C₃N₄ and Fe/g-C₃N₄ resulted in substantial improvements, with germination percentage (GP) increasing to 11% and 15%, respectively (FIG. 3H). Under control conditions, seeds primed with g-C₃N₄ and Fe/g-C₃N₄ showed an increase in germination percentage (GP) by 4% and 6%, respectively.

Fe/g-C₃N₄ priming demonstrated greater effectiveness than g-C₃N₄ alone, as indicated by the enhanced improvements in GP under both control and drought conditions. The observed enhancement may result from the synergistic effects of the g-C₃N₄ matrix and iron doping, potentially improving nutrient availability, enzyme activation, and antioxidant defence mechanisms. Prior work demonstrated that iron priming enhances rice seed germination under drought stress. A similar study demonstrated that priming rice with iron oxide nanoparticles enhanced GA production, which in turn increased amylase activity and accelerated seed germination in primed seeds compared to the control. Apart from these results, various studies recognize the essential role of iron in enhancing seed germination across diverse crop species, both in bulk and nanoform, under drought stress. These findings support the results of the improved seed germination in the Fe/g-C₃N₄ priming observed in the current study.

To further ascertain the ability of priming against drought stress, the shoot and root lengths of rice seedlings under various treatments were examined (FIG. 3G). Seedlings germinated from the seeds primed with Fe/g-C₃N₄ revealed an increase of 20% for shoots and 42% for roots under control conditions, compared with shoot and root length increases of 13% and 25%, respectively, for those primed with g-C₃N₄. The nanomaterial priming, particularly the iron-doped variant, may facilitate enhanced water uptake, which in turn enhances the activity of hydrolytic and antioxidant enzymes, thereby promoting seedling growth, leading to an increase in root and shoot length. PEG-induced drought stress had a detrimental impact, thereby, reducing shoot and root length by 52% and 14%, respectively. Drought stress always limits water availability to the roots, thereby, adversely affects seedling growth in rice. However, under stress conditions, priming with g-C₃N₄ showed a restorative effect, with a 61% increase in shoot length and a 55% increase in root length. Fe/g-C₃N₄ priming under drought stress showed a most significant increase of 89% in shoot length and 84% in root length (FIG. 31). These findings show that priming with Fe/g-C₃N₄ can greatly reduce the negative impacts of stress on seedling development.

Studies on rice plants subjected to drought stress have consistently shown a reduction in both fresh and dry biomass. Similarly, in the current study, 15% PEG-induced drought stress significantly reduced shoot and root fresh weights by 54% and 31%, respectively, and reduced root and shoot dry weights by 41% and 49%, respectively (FIGS. 3J and 3K). Seeds primed with g-C₃N₄ showed significant resilience under drought stress, with increases in shoot and root fresh weights of 41% and 45%, respectively. Fe/g-C₃N₄ priming resulted in significant enhancements, increasing shoot fresh weight by 62% and root fresh weight by 57% under identical conditions (FIG. 3J). The most significant enhancement was noted in shoot and root dry weights under PEG-induced stress, with Fe/g-C₃N₄ priming resulting in increases of 131% and 92%, respectively, demonstrating its effectiveness in alleviating drought-induced stress and promoting biomass accumulation (FIG. 3K). Under control conditions, both g-C₃N₄ and Fe/g-C₃N₄ priming enhanced the fresh and dry weights of shoots and roots, with Fe/g-C₃N₄ exhibiting more significant effects (FIGS. 3J and 3K). Increased water uptake by the development of extensive and profound root systems, together with the accumulation of osmolytes and osmo-protectants, constitutes crucial processes for drought resistance and biomass enhancement. The noted enhancement in the root length of g-C₃N₄ and Fe/g-C₃N₄, primed plants, along with the observed increase in water absorption resulting from zero valent iron priming, can be ascribed to the augmentation in the dry and fresh weight of primed plants.

### Pigment Composition and Photosynthetic Parameters

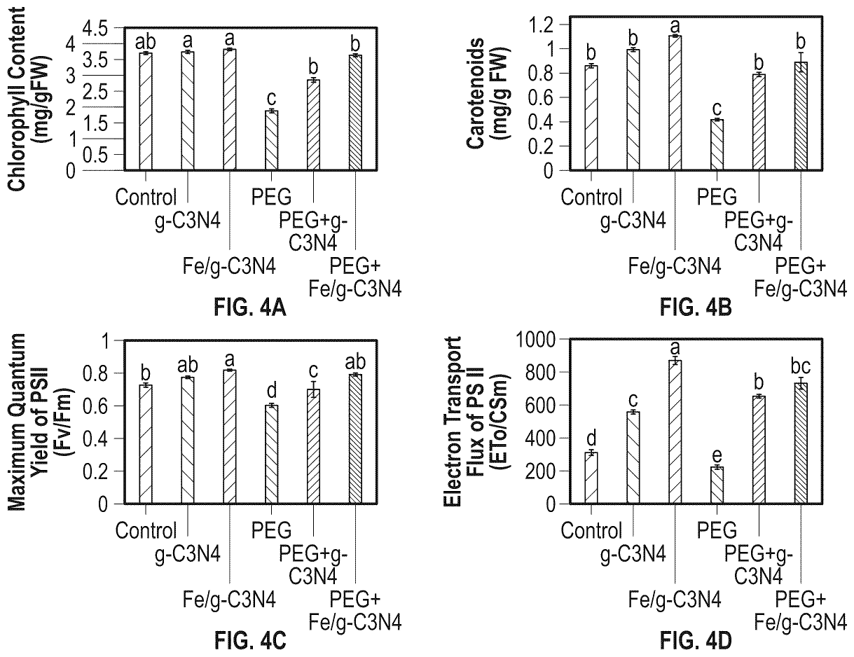

Exposure to drought stress induced by 15% PEG significantly reduces chlorophyll content by 50%, demonstrating the severe impact of drought stress. Remarkably, when seeds were primed with g-C₃N₄ and exposed under PEG induced stress, chlorophyll content rises by 52%, highlighting a substantial improvement in chlorophyll retention. This effect is even more pronounced with the Fe/g-C₃N₄ priming, which results in a dramatic increase of 94% in chlorophyll content (FIG. 4A). Similarly, Under PEG induced stress, there is a notable reduction in carotenoid content by 52%, reflecting the detrimental effects of PEG-induced stress. However, priming with g-C₃N₄ under PEG stress results in an impressive 90% increase in carotenoid content, suggesting a strong ameliorative effect against stress. The most substantial increase is observed with the PEG and Fe/g-C₃N₄ combination, which elevates carotenoid content by 114% (FIG. 4B). Under control conditions, priming with g-C₃N₄ and Fe/g-C₃N₄ slightly increases chlorophyll content (0.9%, and 3%), however, the carotenoid content was significantly enhanced by g-C₃N₄ and Fe/g-C₃N₄ priming (15% and 25%; FIGS. 4A and 4B).

Similarly, the data provides insight into the percentage changes in the maximum quantum yield of photosystem II (Fᵥ/Fₘ) and the electron transport rate per cross-section (ET₀/CSₘ) in rice seedlings under various treatments. Under control conditions, priming with g-C₃N₄ resulted in an increase in Fᵥ/Fₘ by 8% and ET₀/CSₘ by 90%, indicating improved photosynthetic efficiency and electron transport. Fe/g-C₃N₄ priming further enhanced these parameters, with a 13% increase in Fᵥ/Fₘ and a significant 210% rise in ET₀/CSₘ (FIG. 4C). PEG-induced stress caused a substantial decrease, with Fᵥ/Fₘ dropping by 18% and ET₀/CSₘ by 59%, highlighting the detrimental impact of PEG stress on photosynthetic performance. Notably, the combination of PEG stress and g-C₃N₄ treatment improved Fᵥ/Fₘ by 16% and dramatically boosted ET₀/CSₘ by 437%, showing a robust protective and enhancing effect. The most pronounced improvements were seen with PEG and Fe/g-C₃N₄, which increased Fᵥ/Fₘ by 31% and ET₀/CSₘ by 504% (FIG. 4D).

Previous studies on the photosynthetic activity of rice reveals that drought stress significantly impacts both the pigment composition, electron transport rate and the quantum yield of PS II, which is also apparent in the findings obtained from the current study. The significant improvement in these pigment compositions and fluorescence especially in Fe-coated graphitic carbon nitride highlights the plausible role of priming agent in maintaining photosynthetic efficiency by averting drought induced damage to photosynthetic machinery. Prior studies showed that using zero-valent Fe as a seed priming agent in rice resulted in higher amounts of photosynthetic pigments, that improved seedling development. Given that the doped material contains zero-valent Fe, it presents a possible mechanism for improving numerous parameters, including chlorophyll and carotenoid content, even better than what was observed in the case of g-C₃N₄.

### Quantification of Lipid Peroxidation

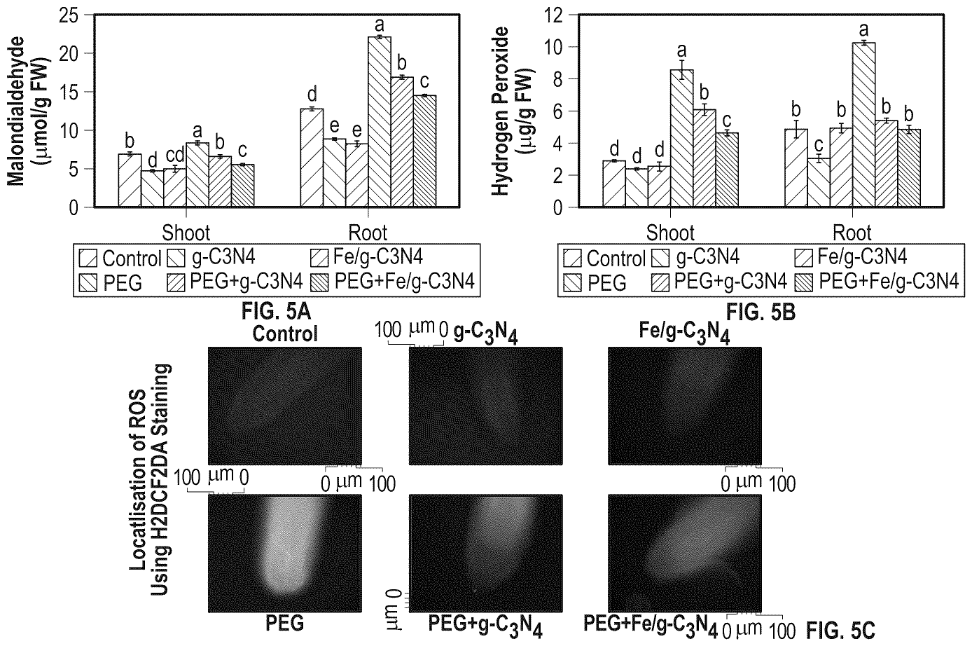

Malondialdehyde (MDA) is a key indicator for assessing the extent of lipid peroxidation. Previous studies on rice under drought stress have demonstrated that MDA content increases with the severity of stress. The present study corroborates these findings, as polyethylene glycol (PEG) treatment, which mimics stress conditions, significantly elevated MDA levels. Compared to the control, MDA levels increased by 22% in shoots and a remarkable 73% in roots, underscoring the oxidative stress induced by PEG treatment. However, when rice seedlings germinated from the seeds primed with a combination of PEG and g-C₃N₄, the MDA content in shoots and roots decreased by 20% and 24%, respectively, compared to the control. The combination of PEG and Fe/g-C₃N₄ further amplified the reduction in MDA content, with decreases of 33% in shoots and 34% in roots. Under control conditions, treatments with g-C₃N₄ and Fe/g-C₃N₄ showed significant reductions MDA content, with g-C₃N₄ decreasing both shoot and root MDA by 31%, and Fe/g-C₃N₄ reducing shoot MDA by 27% and root MDA by 36% (FIG. 5A).

The reduction in MDA indicates a strong antioxidant effect of priming. Various studies in rice and other crop plants have proven that both the bulk and nano priming reduces the MDA levels in plants restoring their homeostasis. A reduction in MDA levels indicates a potent antioxidant effect of priming. Numerous studies in rice and other crop plants have demonstrated that both bulk and nano-priming effectively lower MDA levels, thereby restoring homeostasis. This is evident in the current study, where nano-priming lowered the MDA content and enhanced both morphological as well as physiological parameters. Thus, the results suggest that priming seeds with g-C₃N₄ and Fe/g-C₃N₄ provides a protective effect against PEG-induced oxidative stress, as well as fertilizing effects as it significantly lowering MDA levels in both shoots and roots of rice seedlings.

### Estimation of Stress Indicators

Hydrogen peroxide, proline, and superoxide serves as indicators of assessing the extent of oxidative stress experienced by plants. Quantifying these indicators is crucial for evaluating the extent of oxidative damage in plants. The acquired dataset depicts the measurement of these stress indicators in rice seedlings exposed to various priming treatments with and without 15% PEG. Drought stress leads to increased production of H₂O₂, which in turn elevates lipid peroxidation measured by MDA levels, a specific sign of oxidative damage. In the current study, exposure to drought stress (by 15% PEG) results in a substantial increase in hydrogen peroxide levels, with shoots experiencing a 195% increase and roots experiencing a 111% increase. Additionally, there was an elevation in MDA levels, as previously mentioned in the text. However, when seeds primed with g-C₃N₄ are exposed to 15% PEG, hydrogen peroxide levels are significantly reduced by 29% in shoots and 47% in roots. Similarly, priming with Fe/g-C₃N₄ under drought stress decreases hydrogen peroxide levels by 45% in shoots and 53% in roots, showcasing the pronounced effect of the priming (FIG. 5B). Priming with g-C₃N₄ and Fe/g-C₃N₄ under control conditions also reduced the hydrogen peroxide levels in roots and shoots (FIG. 5B). These results were further validated by the H₂DCFDA staining for the quantification of superoxide (FIG. 5C).

The levels of H₂O₂ in both primed and unprimed rice roots were confirmed using 2′,7′-dichlorodihydrofluorescein diacetate (H₂DCFDA) staining with the help of an upright fluorescence microscope (Leica DM6 B). This analysis employed the fluorescence characteristics of 2′,7′-dichlorofluorescein (DCF), a compound known for its strong fluorescent properties. This approach involves the reaction of H₂O₂ with H₂DCFDA, resulting in its oxidation to DCF. The fluorescence intensity obtained acts as a measure of relative H₂O₂ concentrations, offering a confirmative method for evaluating oxidative stress and H₂O2 in plant tissues. Under PEG-induced drought stress, fluorescence intensity is significantly elevated, indicating increased ROS accumulation due to oxidative stress, which corroborates the quantification results of hydrogen peroxide. Seedlings primed with g-C₃N₄, or Fe/g-C₃N₄ show significantly lower fluorescence than the PEG-stressed, non-primed samples. Fe/g-C₃N₄-primed seedlings exhibit the lowest fluorescence levels, indicating a superior capacity for reactive oxygen species scavenging and enhanced antioxidative defence mechanisms (FIG. 5C). The decrease in ROS levels exhibited by the fluorescence as well as spectrophotometric assay in primed seedlings might be associated with enhanced drought tolerance, evidenced by reduced membrane damage and lower hydrogen peroxide content. Numerous reports also indicate that nano priming with various oxide forms reduces hydrogen peroxide levels, thereby suggesting a decrease in osmotic stress. Studies also indicate that FeO nanoparticle priming in seeds aids in generating small amounts of H₂O₂ during the initial stages of germination, which subsequently decreases when exposed to stress.

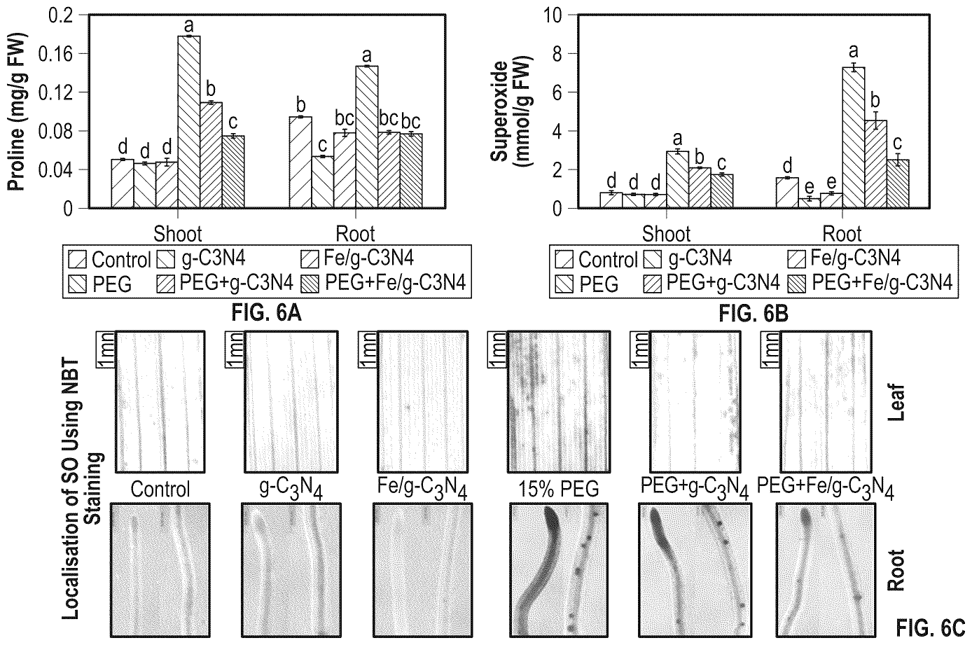

Proline serves as an osmo-protectant, accumulating at high levels in plants subjected to water or drought stress, thus protecting the cell by balancing the osmotic potential of the cytosol with that of the vacuole and the external environment. In the current study exposure to drought induced by PEG significantly elevates proline levels, with shoots increasing by 253% and roots by 55%. However, the seedling with g-C₃N₄ priming leads to a substantial reduction in proline levels upon exposure to drought, showing a decrease of 38% in shoots and 47% in roots compared to the stress. Similarly, Fe/g-C₃N₄ priming under drought stress results in even greater reductions, with proline levels decreasing by 58% in shoots and 48% in roots compared to the stressed plants. In comparison to the control, proline levels were elevated, demonstrating its role as an osmo-protectant, with priming further enhancing these levels. Under control condition compared to the control plants, priming with g-C₃N₄ and Fe/g-C₃N₄, results in a reduction of proline (7% and 5% in shoots as well as 43% and 17% in roots; FIG. 6A).

Prior studies found that rice seedlings subjected to in vitro drought stress for 10 and 20 days exhibited elevated concentrations of superoxide anion (O_{2·}⁻) and enhanced levels of lipid peroxidation in comparison to control seedlings. Similarly, in the current study drought stress administrated by the application of 15% PEG caused a dramatic increase in superoxide levels, by 262% in shoots and 361% in roots. However, when seeds were primed with g-C₃N₄ and subjected to drought, superoxide levels decreased by 29% in shoots and 38% in roots. Similarly, priming with Fe/g-C₃N₄ under drought stress led to a decrease in superoxide levels by 41% in shoots and 65% in roots compared to stress. Under the control conditions, priming with g-C₃N₄ led to a reduction in superoxide levels by 10% in shoots and 68% in roots. Further, Fe/g-C₃N₄ priming under control conditions resulted in a 12% reduction in shoots and 51% in roots (FIG. 6B). The changes in hydrogen peroxide levels also showcase the same results. This was further validated by the NBT staining method.

Reactive oxygen species (ROS) accumulation in plant organs can be detected through histochemical staining using dyes or fluorescein. The formazan produced from the reaction of NBT with O_{2·}⁻ displays blue spots in plant leaves after chlorophyll removal and in roots. The quantity and intensity of blue formazan spots observed in a unit area of leaves under an upright system microscope indicate an increase or decrease in reactive oxygen species (ROS) production. ROS production was assessed in both primed and unprimed rice leaves under drought-stressed conditions using NBT staining. In control plants, minimal staining was observed, indicating low superoxide levels under non-stress conditions. Roots primed with g-C₃N₄ or Fe/g-C₃N₄ alone exhibited slightly higher staining compared to the control, reflecting mild oxidative responses. In contrast, plants exposed to 15% PEG treatment showed intense blue staining, particularly in the roots, confirming a significant accumulation of superoxide under drought stress. Notably, roots primed with g-C₃N₄ exhibited reduced staining compared to PEG alone, indicating that g-C₃N₄ mitigates oxidative stress (FIG. 6C). The lowest staining was observed in the Fe/g-C₃N₄-treated plants, highlighting the superior antioxidative effect of Fe/g-C₃N₄ priming in reducing superoxide accumulation and enhancing stress tolerance in rice.

### Estimation of Anthocyanin and Total Flavonoids

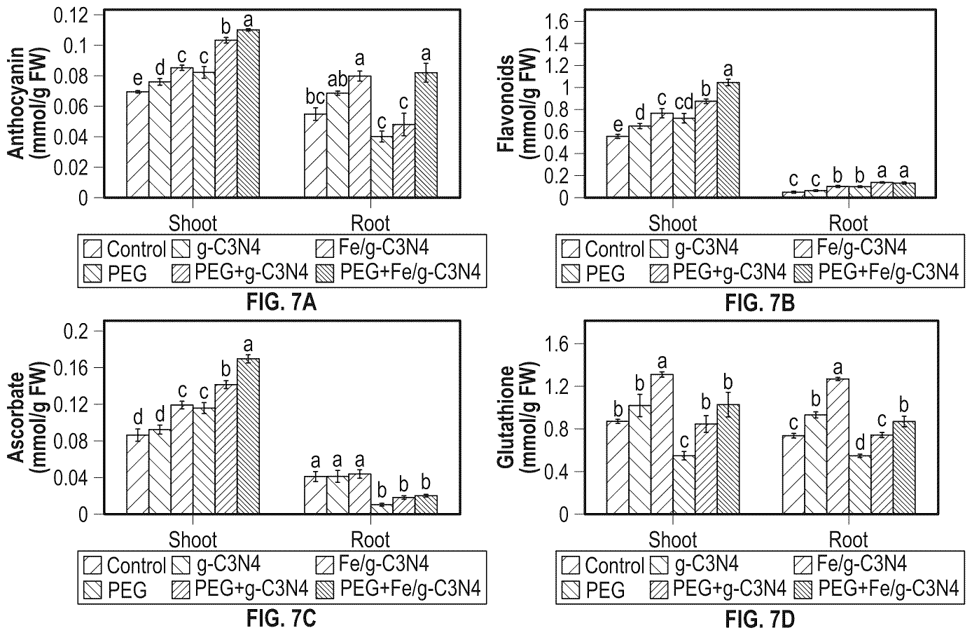

This study analyses the alterations in anthocyanin and total flavonoid content of rice seedlings, both primed and unprimed, under drought stress conditions. Exposure to drought stress induced by PEG resulted in a 19% increase in anthocyanin levels in shoots. Flavonoid levels are significantly elevated by drought stress, resulting to a 92% increase in roots and a 28% increase in shoots. However, drought stress caused a notable decrease of 27% in root anthocyanin content (FIGS. 7A and 7B). Similar research on maize, a closely related species to rice, demonstrated that total anthocyanin and total flavonoids contents are increased during drought stress. Similarly, seedlings grown from seeds primed with g-C₃N₄ and exposed to drought stress exhibit significant increases in secondary metabolite levels. Anthocyanin levels rise by 25% in shoots and 19% in roots under drought stress. Notably, Fe/g-C₃N₄ priming combined with drought stress induces the highest anthocyanin accumulation, with increases of 34% in shoots and 105% in roots. Similarly, flavonoid levels increase by 20% in shoots and 44% in roots in g-C₃N 4-primed seedlings subjected to drought. Interestingly, when Fe/g-C₃N₄ priming is combined with 15% PEG-induced drought stress, flavonoid levels show a further increase, with a 45% rise in shoots and 38% in roots, highlighting the synergistic effects of priming and stress conditions (FIGS. 7A and 7B).

Under control conditions, priming with g-C₃N₄ results in an increase in anthocyanin levels by 9% in shoots and 25% in roots, while those primed with Fe/g-C₃N₄, showed more pronounced increase of 23% in shoots and 45% in roots (FIG. 7A). Similarly, priming with g-C₃N₄ increased flavonoid levels by 16% in shoots and 26% in roots. With Fe/g-C₃N₄ priming, there is a more substantial increase of 37% in shoots and 96% in roots (FIGS. 7A and 7B). The result of this study is corroborated by prior studies that showed that the application of nanoparticles in pigmented rice increases anthocyanin and flavonoid content. Additional prior works also reported similar increases with the application of FeO nanoparticles, which further supports the findings presented herein. Therefore, the additional enhancement of anthocyanin and flavonoids may be attributed to the iron doping in g-C₃N₄.

### Estimation of Non-enzymatic Antioxidants

The data outlines the changes in the ascorbate and glutathione content in rice seedlings under various treatments. Drought stress alone causes a substantial increase in ascorbate content by 34% in shoots. Research on antioxidant defence mechanisms in drought-induced oxidative stress in traditional rice varieties demonstrated that the stress can elicit small quantities of ascorbate, which aligns with the current findings. However, a notable decrease of 75% ascorbate is observed in roots of rice seedlings as reported in prior studies. When seeds are primed with g-C₃N₄ and exposed to PEG stress, the ascorbate content increases by 22% in shoots and 75% in roots, indicating a mitigation of stress effects in roots. Priming with Fe/g-C₃N₄ under the exposure of 15% PEG showed further increases in ascorbate content by 46% in shoots and 95% in roots, showing a strong enhancement (FIG. 7C).

Drought stress significantly reduced glutathione levels, resulting in a 37% reduction in shoots and a 26% decrease in roots. Prior studies assert that glutathione levels decrease under extreme drought conditions, which is similar to the current study. However, when seeds are primed with g-C₃N₄ and exposed to 15% PEG, glutathione content dramatically increases by 55% in shoots and 36% in roots, reversing the negative effects of drought. The most substantial increases are observed with Fe/g-C₃N priming under the exposure of 15% PEG, leading to an 89% increase in shoots and a 61% increase in roots thereby potentially improving the antioxidant capacity and stress resilience of rice seedlings (FIG. 7D). A previous study conducted on tomatoes subjected to drought stress revealed that the administration of nano organic fertilizer enhances the up-regulation of the nitrogen-related antioxidant system in plants, specifically glutathione. g-C₃N₄ is a nitrogen-rich molecule derived from urea; the enhanced availability of nitrogen by priming may have facilitated the synthesis of glutathione in primed plants. Iron doping may have further augmented the same. In comparison to the control without PEG-induced drought stress, priming with g-C₃N₄ and Fe/g-C₃N₄ significantly enhances ascorbate and glutathione levels, corroborating the findings of prior studies.

### Quantification of Iron and Other Essential Elements for Plant Growth Under Drought Stress

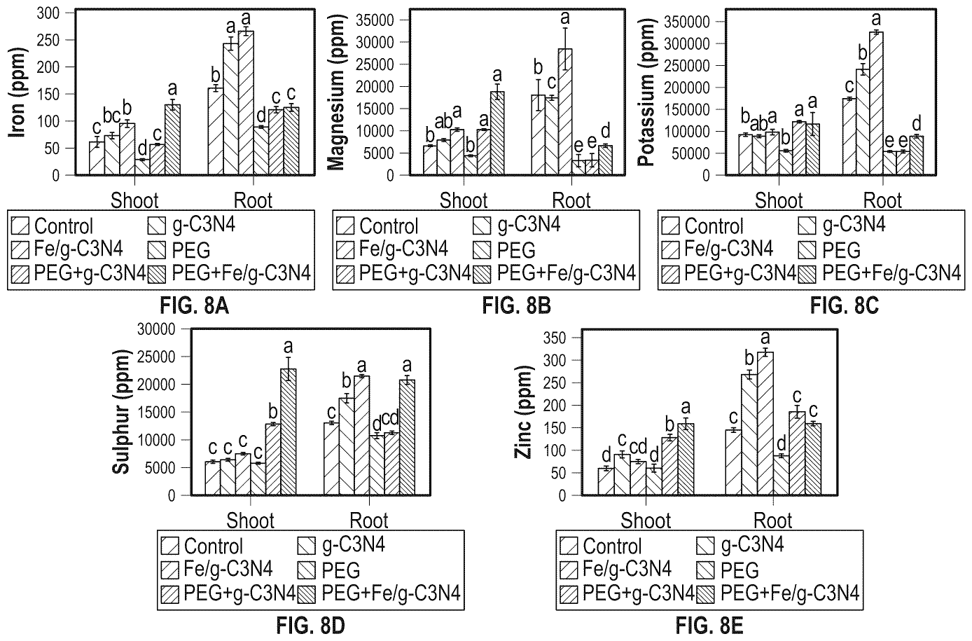

The current study reveals the variations in iron content in the shoots and roots of rice seedlings grown from primed seeds under the presence and absence of PEG induced drought stress. The g-C₃N₄ treatment has led to a 20% augmentation in iron content in the shoot and a 51% rise in the root, demonstrating its efficacy in improving iron absorption. Fe/g-C₃N₄ exhibited further enhancement, with increases of 56% in shoot iron content and 65% in root iron content, thereby illustrating the synergistic effects of iron-doped g-C₃N₄ nanosheets on iron accumulation (FIG. 8A). In contrast, PEG-treated plants demonstrated a notable decline in iron content, with reductions of 54% in the shoot and 45% in the root, likely attributable to stress-induced suppression of Fe absorption. Conversely, the combination of PEG with g-C₃N₄ resulted in a 101% increase in shoot growth and a 37% rise in root growth, indicating that g-C₃N₄ mitigated PEG-induced stress and improved iron absorption. The PEG+Fe/g-C₃N₄ combination exhibited the most substantial improvement, elevating shoot and root iron content by 365% and 40%, respectively, suggesting that Fe/g-C₃N₄ nanosheets can augment iron availability as well as mitigate stress in unfavorable conditions (FIG. 8A).

The data provided herein illustrates the changes in magnesium (Mg) and potassium (K) content in rice seedlings due to seed priming. The application of g-C₃N₄ resulted in a moderate increase in Mg (18%) but a slight decrease in root content (−2.80%). Similarly, for K content a negligible decrease was observed in shoot however, 38% of increase in K was observed in root. However, Fe/g-C₃N₄ treatment significantly enhanced Mg content, showing a 52% increase in the shoot and an impressive 58.38% increase in the root, alongside a substantial rise in K (7% in shoot and 87% in root), indicating its efficiency in nutrient uptake. In contrast, PEG treatment led to a considerable decline in Mg (−33% in shoot and −81% in roots) and K (−40% in shoot and −69% in root), highlighting its negative impact on nutrient accumulation. Interestingly, combining PEG with g-C₃N₄ reversed this trend, causing a significant increase in Mg (127%) and a marginal rise in roots. Similarly, g-C₃N₄ priming increased the shoot K level to 123% and negligible decrease of K content in roots. The PEG+Fe/g-C₃N₄ priming treatment produced the most remarkable improvements, with a dramatic Mg increase of 311.89% in the shoot and 97.48% in the root, alongside significant K enhancements (112.10% in shoot and 61.86% in root) (FIGS. 8B and 8C).

The sulfur and zinc content in rice seedlings showed significant variations in both shoots and roots due to different seed priming treatments compared to the control. g-C₃N₄ priming increased sulfur content by 5% in shoots and 34% in roots, while zinc content increased by 50% in shoots and 83% in roots. Fe/g-C₃N₄ treatment resulted in a further increase of sulfur by 22% in shoots and 64% in roots. Similarly, the zinc content was elevated to 23% in shoots and significantly elevated it to 117% in roots (FIGS. 8D and 8E). PEG treatment, however, caused a notable decrease in both sulfur and zinc content, with sulfur reducing by 5% in shoots and 18% in roots, while zinc content showed a negligible decrease in shoots and 39% in roots. The combined PEG+g-C₃N₄ priming treatment enhanced sulfur (122% in shoots and 6% in roots) and zinc content (112% in shoots and 108% in roots). The most prominent increases were observed with PEG+Fe/g-C₃N₄, where sulfur content surged by 292% in shoots and 95% in roots, while zinc content increased by 164% in shoots but showed a moderate reduction to 80% in roots (FIGS. 8D and 8E). These findings highlight the differential responses of sulfur and zinc accumulation in rice seedlings under various priming conditions, with PEG+Fe/g-C₃N₄ exhibiting the most substantial enhancements overall.

The observed increase in Fe and Mg concentrations due to priming, especially with Fe/g-C₃N₄, contributes to the biosynthesis of chlorophyll, which is vital in maintaining photosynthetic efficiency under drought conditions. Magnesium is the central atom in chlorophyll, while iron is important for enzymes involved in chlorophyll synthesis. Additionally, the homeostasis of potassium (K) plays a crucial role in regulating stomatal activity, facilitating water uptake, and adjusting osmotic balance, all of which contribute to maintaining appropriate cell turgor and overall plant growth during water-deficit stress. The augmentation of potassium in primed seedlings could have played a major role in maintaining their osmotic balance compared to stressed and control seedlings. The primed seedlings also augmented the reduced S due to stress also could led to increased production of glutathione (GSH), an important antioxidant molecule that protects plant cells from oxidative damage by blocking reactive oxygen species (ROS) caused by drought stress. The increased zinc (Zn) could likewise have caused increased accumulation, promoting both ascorbate and superoxide dismutase (SOD) activities, which are the most active components of the antioxidative defense system. Ascorbate is the main ROS scavenger, and SOD changes harmful superoxide radicals into less harmful hydrogen peroxide. This lowers oxidative stress in cells.

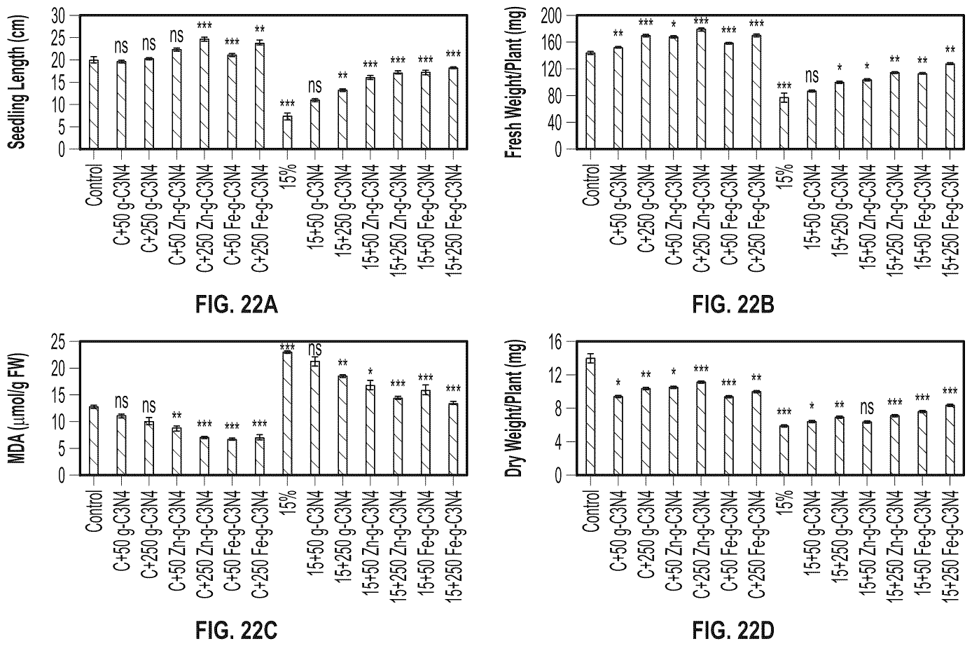

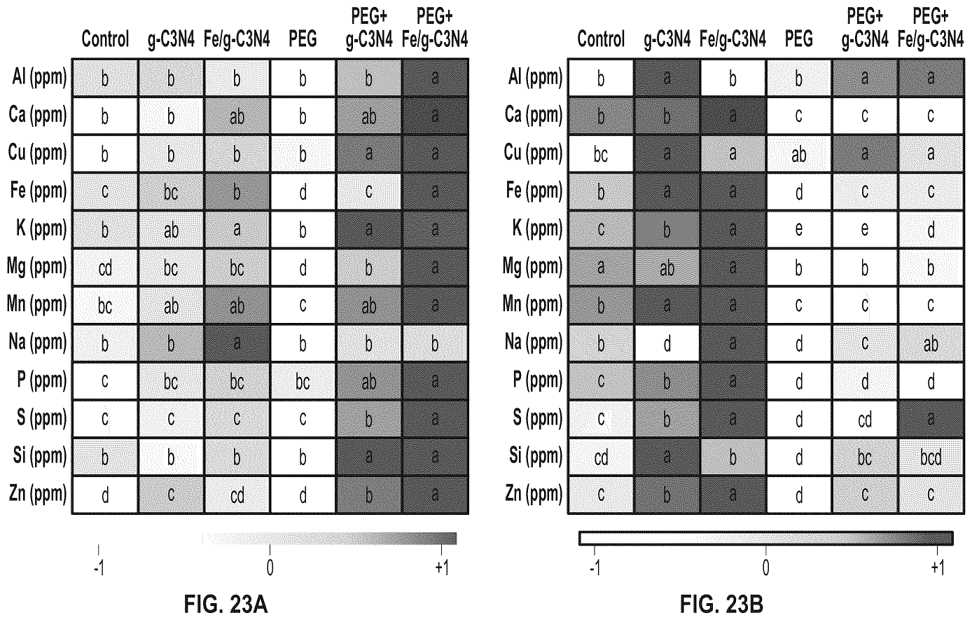

Most essential elements, including Al, Ca, Cu, Mn, Na, P, Si, and others, were significantly down-regulated by PEG-induced drought stress in the shoots and roots of rice seedlings (FIGS. 22A and 22B). Under stress conditions, the priming treatments resulted in improved retention or augmentation of most of the elements, particularly Fe, Mg, Zn, S, and K. Seed priming techniques such as g-C₃N₄ and Fe/g-C₃N₄ substantially mitigated the adverse effects of drought stress by improving the uptake and accumulation of essential nutrients, therefore restoring homeostasis in plant tissues. The favorable effect of g-C₃N₄ root-application on elemental accumulation, including Ca, Cu, Fe, K, Mg, Mn, P, and S, in improving nutritional absorption and assimilation as reported in prior studies supports the current findings. According to these studies, g-C₃N₄, as a nanomaterial, has unique physicochemical features that can boost the availability and absorption of important nutrients by plants. The synergetic effect of Fe/g-C₃N₄ can be correlated with the presence of iron in small amount. This indicates that priming significantly mitigates nutrient deficit induced by drought stress, hence enhancing plant growth and resilience.

### Estimation Growth Parameters Under Arsenic Stress and Influence of Priming

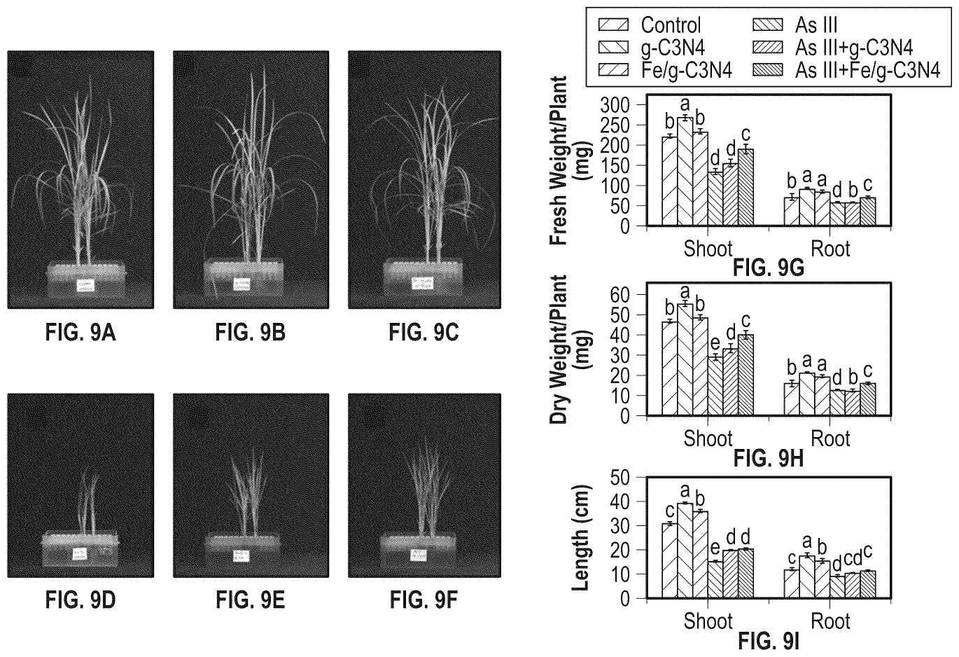

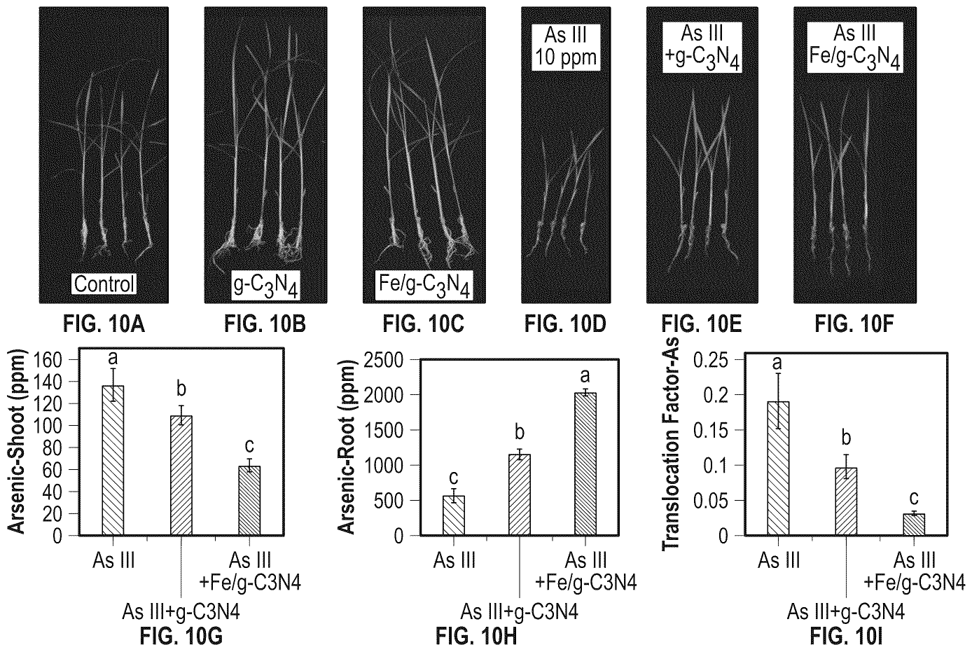

Toxic metal stress poses a serious threat to plant growth and development, disrupting physiological and metabolic processes. Among these, toxic metals like arsenic (As III) significantly impair rice growth by reducing root and shoot length, biomass, and overall plant vigor. The current study shows that arsenic (As III) stress induces significant growth defects in rice seedlings, including stunted growth, reduced shoot height, and poor leaf development, reflecting severe toxicity (FIG. 9D). However, the addition of amendments like g-C₃N₄ and Fe/g-C₃N₄ partially alleviates these negative effects, leading to recovery in plant height, leaf density, and overall biomass (FIGS. 9E and 9F). In comparison, plants under control conditions exhibit healthy growth with well-developed shoots and roots (FIGS. 10A-F). Interestingly, treatment with g-C₃N₄ and Fe/g-C₃N₄ under non-stressed conditions further enhances plant growth, showing improved shoot length, leaf density, and biomass compared to untreated controls (FIGS. 9A, 9B and 9C).

To determine the stress and priming-induced changes, growth metrics such as fresh weight, dry weight, and length were examined. High arsenic levels reduce photosynthetic efficiency and nutritional uptake, resulting in reduced biomass in both roots and shoots. This was evident in current study as well, where significant differences were observed between rice seedlings grown from primed and unprimed seeds under arsenic stress (10 ppm) in fresh weight. Shoot biomass of unprimed As III plants experienced a sudden decline of 40%, while roots experienced an overall decrease of 18%, significantly affecting the overall fresh weight. Conversely, this stress was mitigated by priming with g-C₃N₄ and Fe/g-C₃N₄. For instance, plants that were primed with Fe/g-C₃N₄ and treated with As III exhibited a remarkable increase in shoot and root fresh weights, each by 41% and 21%, respectively, when contrasted with unprimed plants that were put under stress. In control conditions that were devoid of arsenic, the primed plants exhibited increased growth in comparison to the unprimed controls (FIG. 9G). The enhanced performance of Fe/g-C₃N₄ may be attributed to the doping of g-C₃N₄ with Fe in small amount and in nanoform.

The trend in fresh weight was also reflected in the measurement of dry weight. Under arsenic stress, shoot and root dry weights decrease significantly for unprimed plants, with As III causing a 38% decrease in shoot dry weight and a 21% decrease in root dry weight when compared to the control group. However, priming with Fe/g-C₃N₄ significantly increased plant stress tolerance, with increases of 38% shoot dry weight and 25% under root dry weight, as compared to stress. Under control conditions without arsenic stress, the rice seedlings grown from g-C₃N₄ and Fe/g-C₃N₄ primed seeds showed upregulation of dry weight. However, the Fe/g-C₃N₄ priming improved growth the most, by 5% in shoot weight and 21% in root weight when compared to g-C₃N₄ alone (FIG. 9H).

The length of shoots and roots is adversely impacted by arsenic stress. In the present study under arsenic stress, the shoot and root lengths of seedlings grown from unprimed seeds were diminished by 50% and 23%, respectively, in comparison to the control plants. Priming with g-C₃N₄ and Fe/g-C₃N₄ mitigated this negative impact of stress, with the most pronounced enhancement observed in As III+Fe/g-C₃N₄, where shoot and root lengths increased by 33% and 23%, respectively. Under control conditions devoid of arsenic stress, primed plants exhibited superior growth compared to unprimed plants. The shoot and root lengths of g-C₃N₄ primed plants were 27% and 47% higher, respectively, compared to unprimed plants, while Fe/g-C₃N₄ primed plants exhibited increases of 17% and 31%, respectively (FIG. 91). The further improvement in Fe/g-C₃N₄ may be attributed to the presence of iron nanoparticles. The growth metrics indicate that doping g-C₃N₄ with Fe enhances rice seedling growth under both stressed and unstressed conditions.

### Quantification and Translocation of Arsenic

Arsenic (As III) accumulation and distribution in rice plants subjected to 10 ppm arsenic stress reveal significant effects of priming with g-C₃N₄ and Fe/g-C₃N₄. In the shoots, unprimed plants exhibited 136 ppm of As III in dry weight, while priming with g-C₃N₄ and Fe/g-C₃N₄ reduced As III accumulation significantly by 20% and 54%, respectively (FIG. 10G). This reduction highlights the ability of priming agents to limit arsenic translocation to shoots. However, in the roots, a contrasting pattern was obtained. Unprimed plants exposed to arsenic stress accumulated 566 ppm of As III, while priming further increased As III content in roots. Specifically, priming with g-C₃N₄ led to a 104% increase, and priming with Fe/g-C₃N₄ resulted in a 260% increase in root arsenic content (FIG. 10H). This substantial accumulation of As III in roots, coupled with reduced translocation to shoots, suggests that priming agents, particularly Fe/g-C₃N₄, effectively confine arsenic to the root system. This root confinement mechanism was further validated by the translocation factor, which confirmed limited upward movement of arsenic in primed plants.

The translocation factor (TF) values indicate the movement of arsenic (As III) from roots to shoots under different treatments. In unprimed plants subjected to As III treatment, the translocation factor (TF) was 0.19141, indicating significant arsenic movement to the shoots. Priming with g-C₃N₄ decreased the TF to 0.09763, signifying limited arsenic mobility. The lowest TF of 0.03106 was reported in plants primed with Fe/g-C₃N₄, suggesting its superior capacity to prevent arsenic transport and limit it to the roots. These results emphasize that both priming agents, especially Fe/g-C₃N₄, significantly inhibit arsenic migration to shoots, reaching it to grain thus limiting its biomagnification and neutralizing its harmful effects (FIG. 10I). Previous investigations have indicated that g-C₃N₄ root treatment inhibits the translocation of As III to shoots. The additional decrease in the translocation of As III by Fe/g-C₃N₄ is ascribed to the incorporation of nano Fe inside the g-C₃N₄. Thus, this study suggests that g-C₃N₄, and Fe/g-C₃N₄ priming especially Fe/g-C₃N₄ priming can alleviate the negative impact of drought and As III stress.

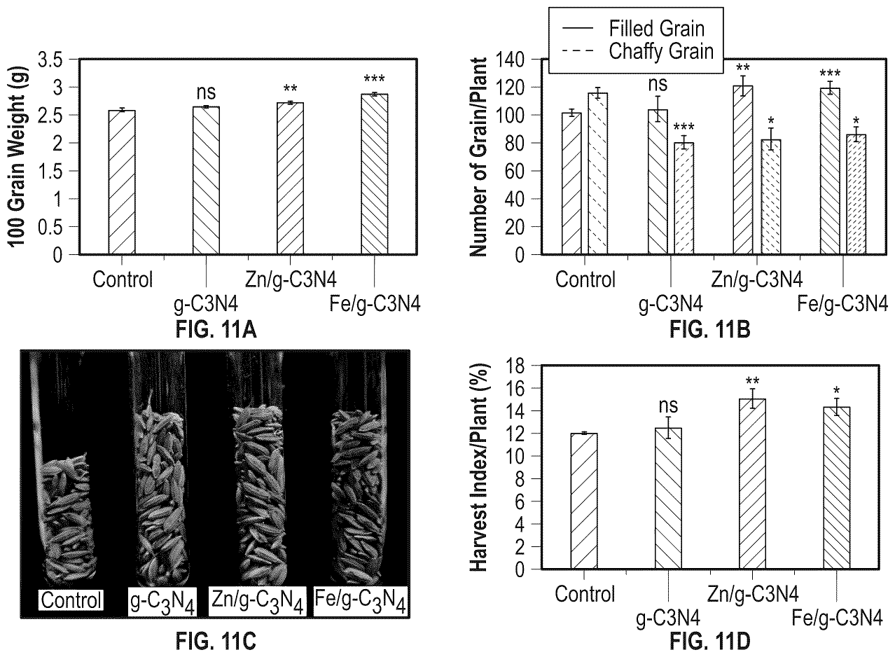

Rice grain yield was significantly increased at maturity in rice plants from the primed seeds with g-C₃N₄, Fe/g-C₃N₄, Zn/g-C₃N₄. FIG. 11 shows the potential yield of rice plants subjected to various priming treatments; control (hydro-primed), g-C₃N₄, Zn/g-C₃N₄, and Fe/g-C₃N₄. Priming of seeds with g-C₃N₄ resulted in a 2% increase in both the weight of 100 grains and the number of filled grains, with a 30% reduction in empty chaffy grains (FIGS. 11A-11C). Zn/g-C₃N₄ demonstrated significant effects compared to the control, resulting in a 5% increase in grain weight, a 19% rise in filled grains, and a 28% reduction in chaffy grains. Fe/g-C₃N₄ displayed a maximum enhancement in 100 grain weight of 11%, 17% increase in filled grains, and a 26% reduction in chaffy grains (FIGS. 11A-11C). This resulted in a further improvement in the harvest index (HI), with g-C₃N₄ increasing the HI by 4%, while Zn/g-C₃N₄ and Fe/g-C₃N₄ significantly increasing it by 26% and 19%, respectively (FIG. 11D).

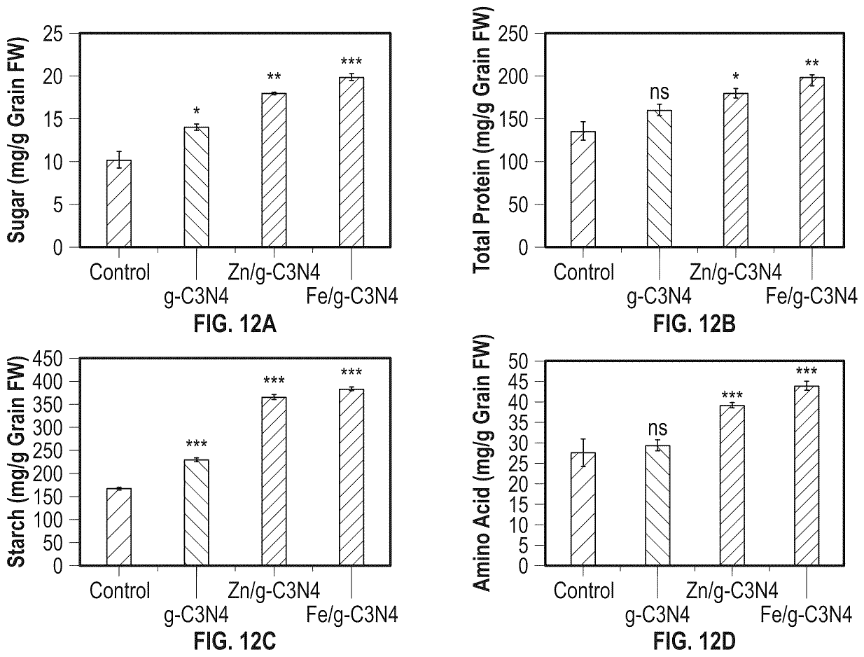

Further, there was a substantial increase in the nutritional composition of rice grains harvested from plants grown after seed priming with g-C₃N₄, Zn/g-C₃N₄, and Fe/g-C₃N₄ compared to the control. Specifically, total protein content increased by 18%, 33%, and 44% under g-C₃N₄ Zn/g-C₃N₄, and Fe/g-C₃N₄ treatments, respectively (FIG. 12A). Free amino acid content showed a remarkable enhancement of 7%, 42%, and 59%, while sugar content increased by 38%, 77%, and 95% for g-C₃N₄, Zn/g-C₃N₄, and Fe/g-C₃N₄ respectively (FIGS. 12B-12C). Similarly, starch accumulation exhibited a significant increase of 37%, 118%, and 129% for g-C₃N₄, Zn/g-C₃N₄, and Fe/g-C₃N₄, respectively (FIG. 12D).

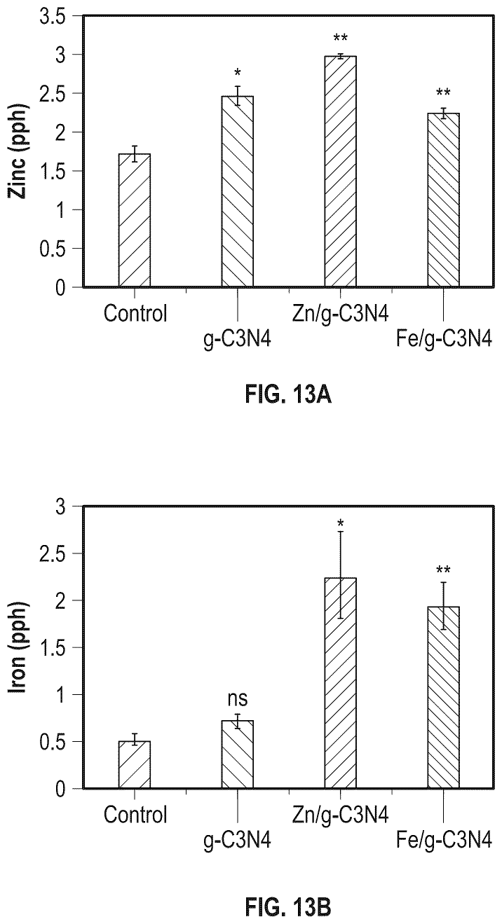

The seed priming treatments with g-C₃N₄, Zn/g-C₃N₄, and Fe/g-C₃N₄, showed a significant increase in the essential elements, compared to the control. Iron (Fe) and zinc (Zn) are critical essential nutrient element and are most deficient in food crops. The elemental analysis of iron (Fe) and zinc (Zn) in grains harvested from the plants grown after seed priming with different treatments reveals significant variations compared to the control (FIG. 13A). There was a significant elevation of Fe content with Zn/g-C₃N₄ treatment (339%), followed by Fe/g-C₃N4 (277%) and g-C₃N₄ (40%). Similarly, Zn accumulation was highest in Zn/g-C₃N₄ treatment (73%), followed by g-C₃N₄ (42%), while Fe/g-C₃N₄ treatment showed a relatively lower increase (31%) (FIGS. 13B-13C). These findings highlight the potential of Zn/g-C₃N₄ and Fe/g-C₃N₄ seed priming in optimizing Fe and Zn content in rice, offering a promising biofortification strategy to combat micronutrient deficiencies in crops.

### Fe/g-C₃N₄ Induced Drought Tolerance in Rice—at Maturity

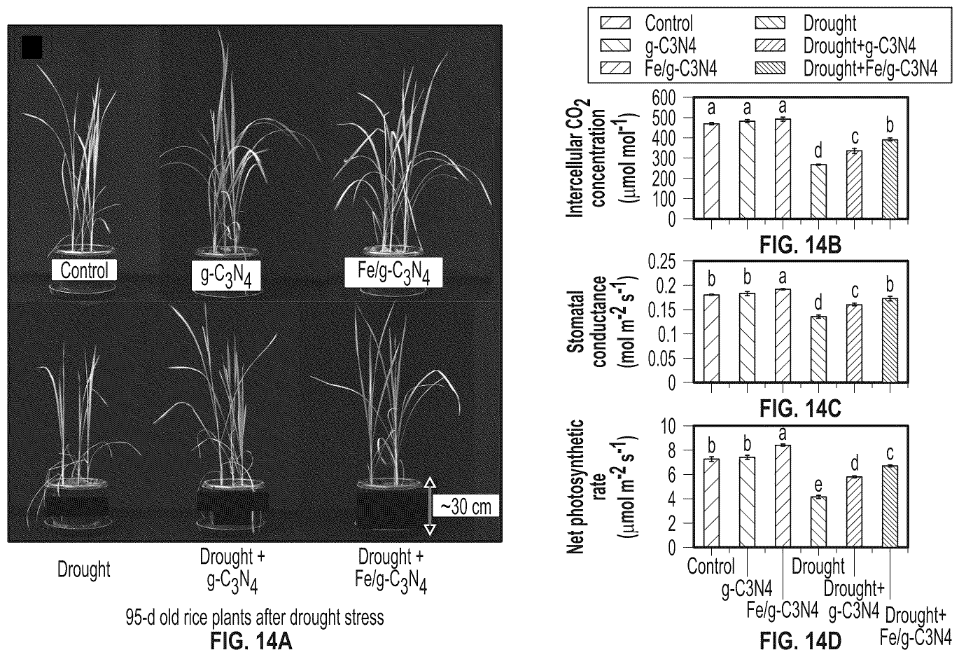

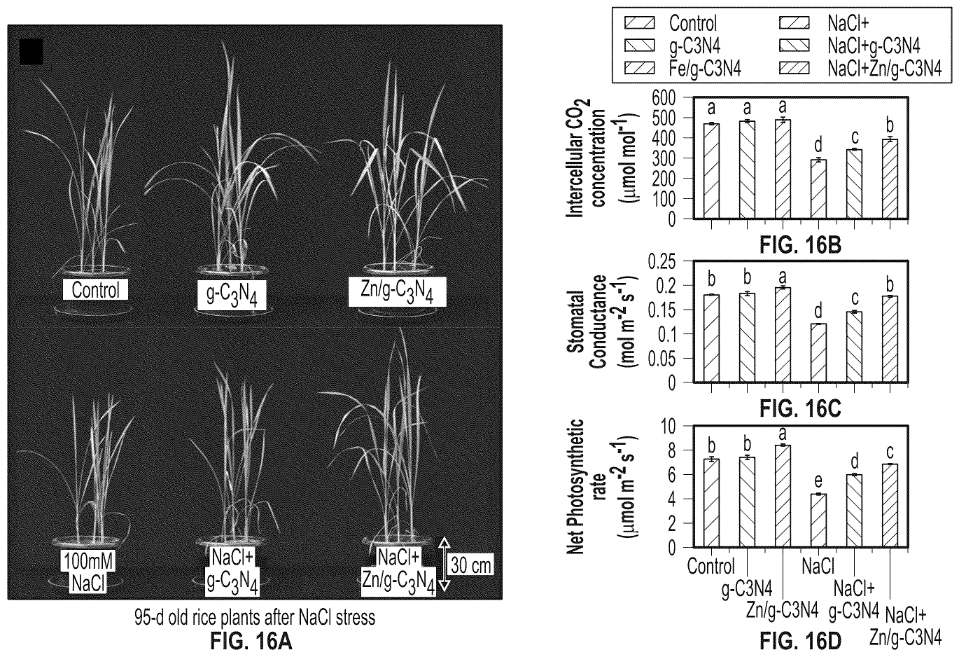

The drought induced by the reduction in water level to 50% of field capacity significantly impacted the plant phenotype (FIG. 14A). The phenotypic changed induced by drought stress substantially affected the key physiological parameters directly related to gas exchange and photosynthesis, including stomatal conductance (gs; 25%), intercellular CO₂ content (Ci; 43%), and net photosynthetic rate (Pn; 43%) (FIG. 16B-16D). However, the g-C₃N₄ and iron functionalized g-C₃N₄ (Fe/g-C₃N₄) mitigated by the adverse impacts of drought on photosynthesis. The Fe/g-C₃N₄ priming showed most significant enhancement surpassing the g-C₃N₄ priming, resulted in a 46% increase in Ci, a 27% increase in gs, and a 61% increase in Pn relative to unprimed drought-stressed plants. The priming also had a beneficial effect under control conditions, significantly improving the photosynthesis and growth (FIG. 14B-14D).

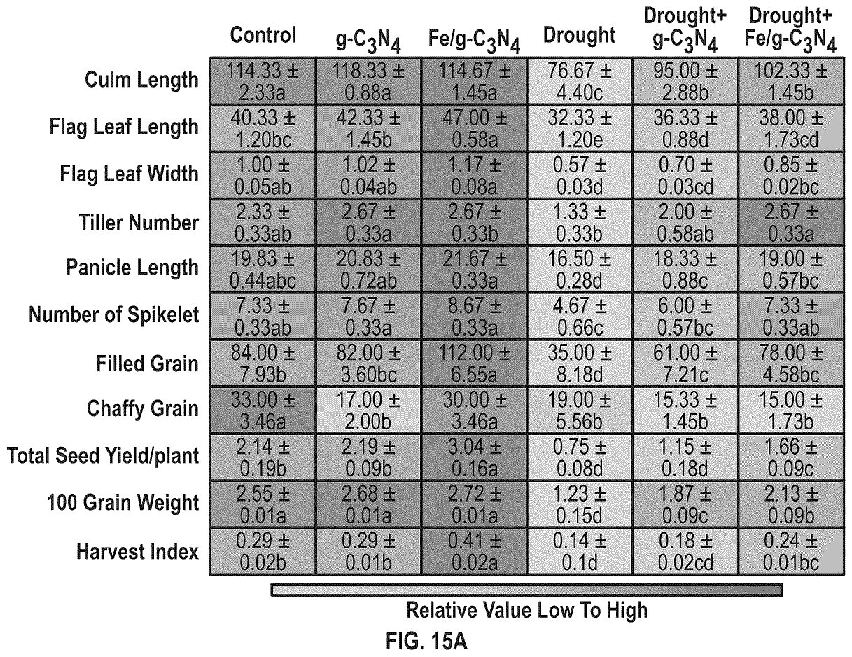

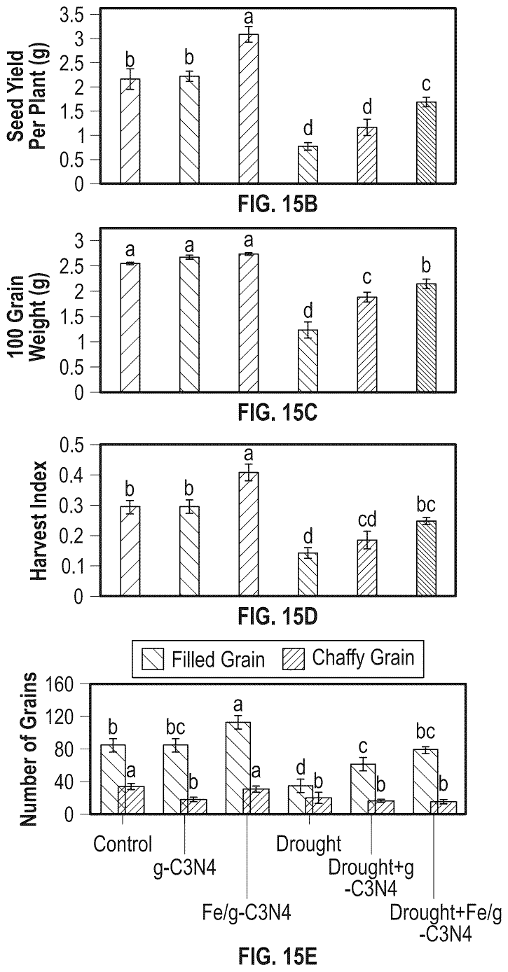

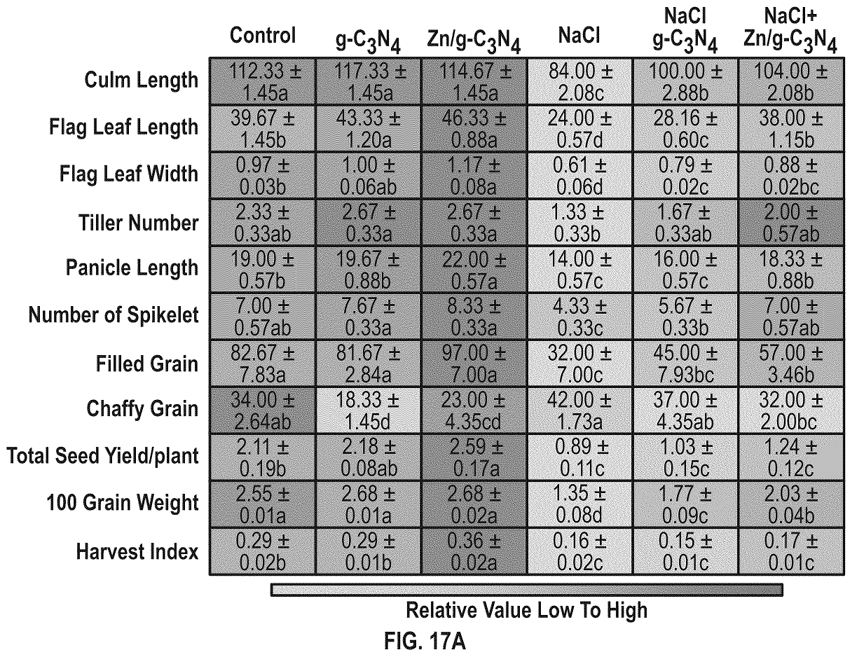

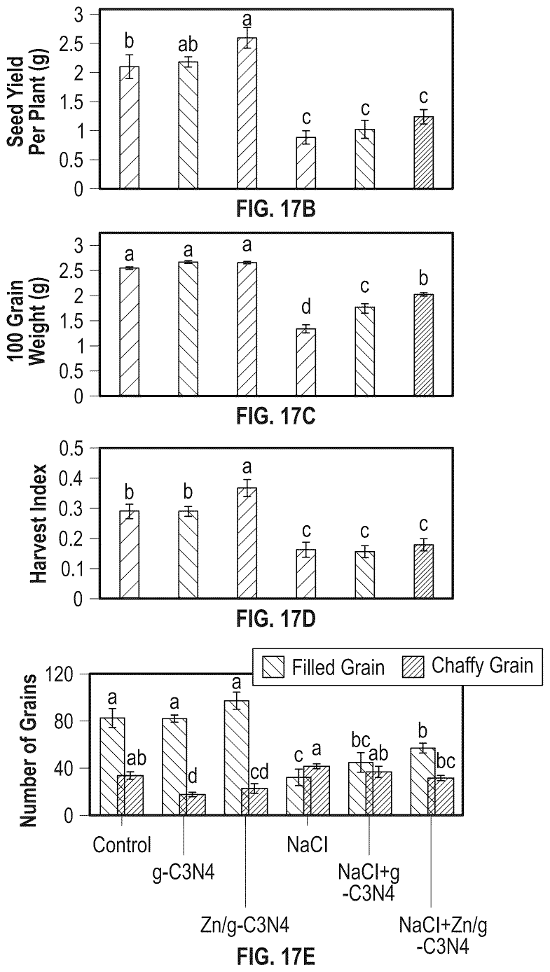

The yield data gathered from 125-day old matured plants after drought stress exposure, revealed the detrimental impact of drought on yield and overall growth (FIG. 15A). The drought induced oxidative stress, significantly reduced the culm length, flag leaf dimension, tiller number, and spikelet count in rice. Compared to well-watered control plants, drought impacted the grain filling and harvest index, with a significant decline in the quantity of filled grains (58%), 100 grain weight (64%), grain per plant (51%), and harvest index (52%), whereas the number of chaffy gains increased significantly (42%) (FIG. 15B-15E). However, the priming with g-C₃N₄ and especially with Fe functionalized g-C₃N₄ (Fe/g-C₃N₄) mitigated the drought induced damage in rice. Priming with g-C₃N₄ resulted in significant enhancements in both vegetative and reproductive characteristics with a 50% increase in total seed yield per plant. Although Fe/g-C₃N₄ priming outperformed g-C₃N₄ with further increment in the number of filled grains (122%), overall seed yield (123%), and the harvest index (74%) under drought stress condition (FIG. 17B-17E). Fe/g-C₃N₄ priming, decreased the number of chaffy grains significantly. Results also clearly showed the fertilization effect of Fe/g-C₃N₄ as it substantially enhanced vegetative development in control conditions devoid of stress (FIG. 15B-15E).

Overall, the phenotypic and yield responses indicate that drought severely disrupts both vegetative growth and reproductive responses, whereas nano-priming especially with Fe-functionalized g-C₃N₄ effectively mitigates these effects by improving growth traits, enhancing grain filling, and restoring yield potential, likely through the beneficial role of Fe in growth and improving photosynthetic efficiency under stress conditions.

### Zn/g-C₃N₄ Enhanced Salinity Tolerance in Rice at Maturity

A significant reduction in plant phenotype was observed under 100 mM NaCl induced stress (FIG. 16A). In addition to the changes in phenotype the NaCl stress induced substantial decreases in key gas exchange parameters related to photosynthesis, including stomatal conductance (gs; 33%), intercellular CO₂ content (Ci; 38%), and net photosynthetic rate (Pn; 39%) (FIG. 16B-16D). However, the adverse impacts of salinity on photosynthesis were mitigated by the g-C₃N₄ and Zn/g-C₃N₄ priming. The most significant enhancement was exhibited by Zn/g-C₃N₄ priming, resulting in a 35% increase in Ci, a 47% increase in gs, and a 56% increase in Pn relative to unprimed NaCl-stressed plants. The priming had a beneficial effect under control conditions, substantially improving the photosynthesis thus highlighting the fertilization impact (FIG. 16B-16D).

The yield data gathered after 125 days of growth revealed that salinity had a negative impact on yield and overall growth (FIG. 17A). The exposure to salinity stress significantly reduced the culm length, flag leaf length and width, tiller number, as well as spikelet count in rice plants. Compared to unstressed control plants, salinity further impacted the grain filling and overall harvest, with a significant reduction in filled grains (61%), 100 grain weight (47%), grain per plant (57%), and harvest index (43%), whereas the number of chaffy gains increased significantly (23%) (FIG. 17B-17E). Conversely, priming induced favourable responses to salinity stress.

The application of g-C₃N₄ and Zn/g-C₃N₄ as seed priming agents showed their ability to mitigate salinity induced damage in rice. Priming with g-C₃N₄ resulted in significant enhancements in both vegetative and reproductive characteristics. However, Zn/g-C₃N₄ priming surpassed g-C₃N₄ in yield parameters especially in the number of filled grains (78%), overall seed yield (39%), and the harvest index (9%) under NaCl stress condition (FIG. 17B-17E). Zn/g-C₃N₄ priming simultaneously, decreased the number of chaffy grains by 23%. Similarly, g-C₃N₄ and Zn/g-C₃N₄ substantially enhanced vegetative development in control conditions devoid of stress. Nonetheless, g-C₃N₄ exerted minimal influence on reproductive efficiency, whereas Zn/g-C₃N₄ priming significantly improved reproductive performance, reflecting higher nutrient use efficiency (FIG. 17B-17E).

The phenotypic and yield responses demonstrate that salinity significantly impairs both vegetative and reproductive growth, while nano-priming, particularly with Zn-functionalized g-C₃N₄, effectively alleviates these adverse effects by enhancing growth characteristics, promoting grain filling, and restoring yield potential, likely due to the role of Zn in augmenting photosynthetic efficiency and increasing antioxidant activity under stress conditions.

### MATERIALS AND METHODS

### Synthesis and Characterization of G-C₃N₄ and Zn/g-C₃N₄

Thermal polycondensation was adopted for synthesizing pristine g-C₃N₄ and Zn/g-C₃N₄. In a typical synthesis, 10 g of urea loaded in a clean alumina crucible was sealed and heated in a muffle furnace at 550 °C for 2 h to obtain g-C₃N₄. For obtaining Fe/g-C₃N₄, a mixture of 0.5 wt % of the metal precursor [Fe(NO₃)₂·6H₂O] with 10 g urea was heated under the same above mentioned conditions. The obtained powders were vacuum-dried after being washed with excess DI water and ethanol to remove impurities. Structural properties of the samples were analyzed using an X-ray diffractometer (X'pert3 Powder, PANalytical) with Cu Kα radiation (λ=1.5418 Å) at a scan rate of 2°/min in the 20 range 10-80 ° (FIG. 18) . The morphology of the samples was analyzed using a Field Emission Scanning Electron Microscope (FESEM, Gemini SEM300) (FIG. 19) . High-resolution transmission electron microscopy (HRTEM), energy dispersive X-ray spectroscopy (EDS), and selected area electron diffraction pattern (SAED) analysis were performed on a transmission electron microscope (JEOL JEM 2010) operating at an acceleration voltage of 200 kV. Samples for TEM were prepared by dropping the sample solution dissolved in ethanol onto a carbon-coated copper grid.

### Seed Materials, Seed Priming, Stress Treatments, Growth Condition and Biomarkers

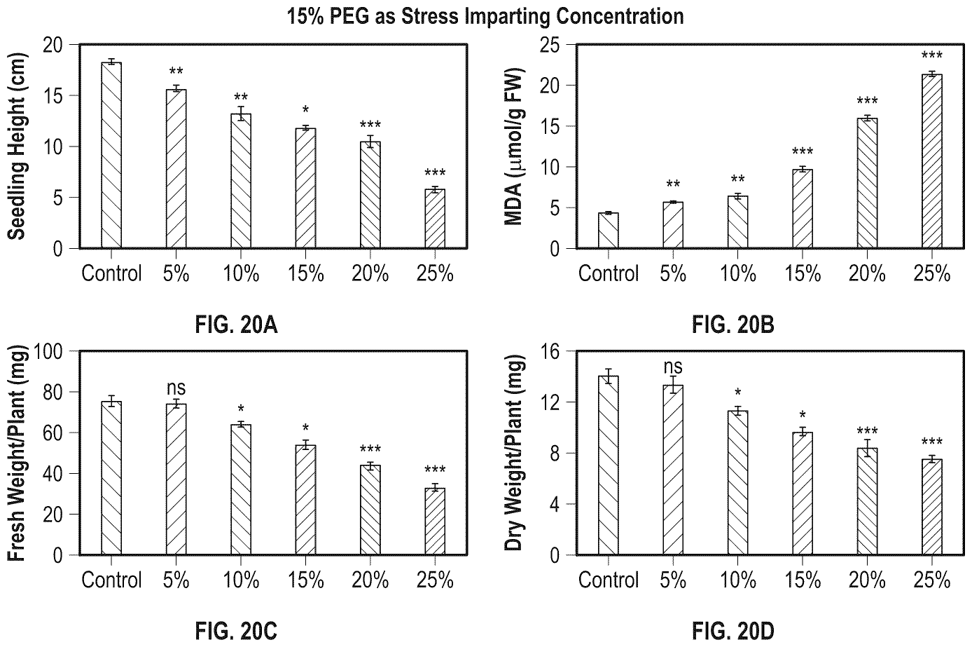

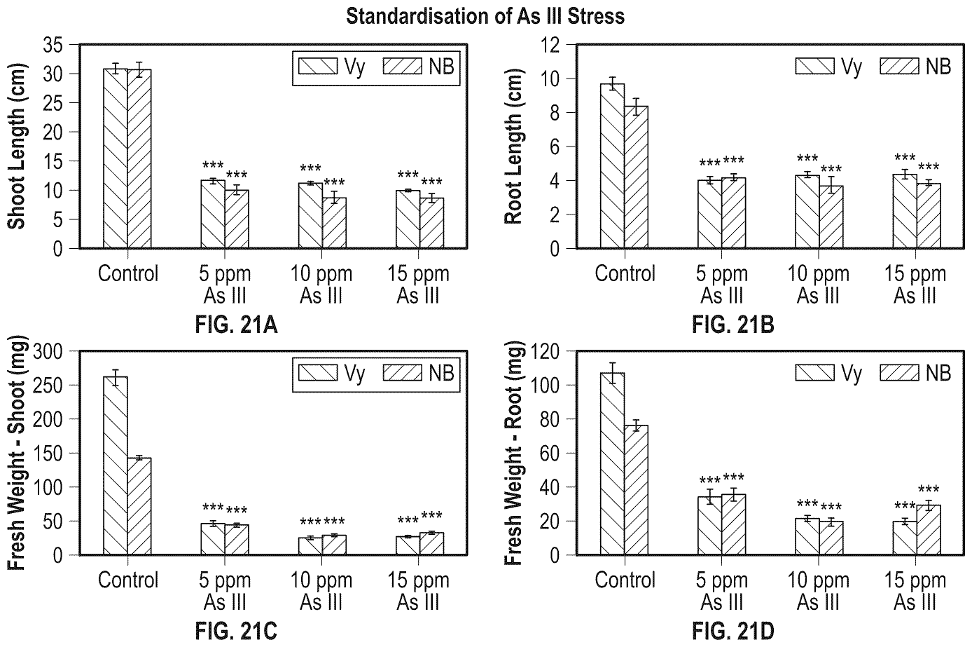

The investigation utilized seeds of Oryza sativa ssp. Indica strain and ssp. Japonica, procured from the Rice Research Station, Vyttila, Kerala, India. Screening experiments to determine the effective priming concentration proved that 250 μg/L of g-C₃N₄ and Fe/g-C₃N₄ are optimal, while 15% polyethylene glycol (PEG- 6000) (FIGS. 19 and 20). To further assess As III stress and compare the tolerance of two subspecies (Japonica and Indica), given that prior studies on As III stress and g-C₃N₄ were conducted on Japonica, standardisation experiments were performed. The findings demonstrated that 10 ppm As III serves as a stress-inducing concentration, while Vy-10 is identified as a tolerant variety (FIG. 20). Previous investigations conducted by our research group on rice utilising g-C₃N₄ and As III via root application indicated that a treatment of 250 μg/L mitigated heavy metal toxicity in Oryza sativa ssp. Japonica. Consequently, the same concentrations of 250 μg/L g-C₃N₄ and Fe/g-C₃N₄ were chosen for the arsenic stress studies.

The seeds underwent five rinses with deionized water (DI) followed by a 10 min surface sterilization with 10% hydrogen peroxide (H₂O₂) solution. The seeds were then placed in conical flasks along with priming solution (g-C₃N₄ and Zn/g-C₃N₄ in DI water) and shaken for 12 h on a mechanical shaker (50 rpm) in the dark, ensuring steady and moderate agitation. A control set of seeds was also treated similarly, without nanomaterials.

The rice seeds were germinated and grown hydroponically in ½strength Hoagland's solution (PhytoTech LAB). Seedlings from primed rice seeds were raised in plastic jars (12×7×5 cm) within controlled conditions of a plant growth chamber. These conditions encompassed ½ strength Hoagland medium (control) and NaCl (100 mM) supplied in ½ strength Hoagland medium (stress), maintaining controlled parameters of temperature (26±2 °C), light intensity (300μmolm⁻²s⁻¹), and relative humidity (55±5%) with a 14/10 h photoperiod. The study comprised different treatments: control, primed unstressed conditions (g-C₃N₄ and Fe/g-C₃N₄), PEG stress (15%), As III stress (10 ppm) and primed seeds subjected to stress (PEG+g-C₃N₄, As III+g-C₃N₄, PEG+Fe/g-C₃N₄ and As III+Fe/g-C₃N₄). The experiments aimed to evaluate the effectiveness of g-C₃N 4 and Fe/g-C₃N₄ as fertilizers and their potential to alleviate salt stress in rice. 21 days old seedlings were used for various assays (considered short-term). Measurements were taken for shoot/root biomass and length from the same seedlings. A portion of the tissues was flash-frozen in liquid nitrogen and stored at 80 °C for biochemical experiments, while the remaining samples were oven-dried for 72 h at 75 °C for elemental analysis.

### Pigment Composition and Photosynthetic Parameter

After homogenizing the leaf samples in 80% acetone (v/v), the homogenate was centrifuged at 4 °C for 5 min at 5000 rpm. Re-extraction of the residue with 80% acetone was carried out until the pellet turned colorless. The total chlorophyll and carotenoid contents of the pooled supernatant were determined by measuring its absorbance at 470, 645, 663, and 750 nm. The Plant Efficiency Analyzer (Handy PEA; Hansatech Ltd., Norfolk, UK), a portable fluorometer, was used to measure the parameters of chlorophyll a fluorescence. The leaf samples were exposed to continuous red light (650nm, 3,000μmol photons m⁻²s⁻¹) produced by an array of three light-emitting diodes focused on a circle of 5 mm diameter on the surface of the leaf samples after being dark-adapted for 20 min using light exclusion clips attached to the leaf surface. Fluorescence measurements were recorded up to 1 s with a data acquisition rate of 10 μs for the first 2 ms and 1 ms thereafter, by illuminating with a continuous red light. The data were examined using the Biolyzer HP3 program (Bioenergetics Laboratory at the University of Geneva in Switzerland).

Estimation of Lipid Peroxidation and ROS

Quantification of malondialdehyde (MDA) content was utilized to determine the rate of lipid peroxidation. The Heath and Packer (1968) protocol was followed to estimate MDA, and the MDA concentration was calculated using its extinction coefficient (155 mM⁻¹ cm⁻¹). Using hydrogen peroxide as a reference, the hydrogen peroxide (H₂O₂) content in the sample was calculated following the protocol of Junglee et al. (2014). Sodium nitrate (NaNO₂) was used as the standard to determine the superoxide (SO) content as per Doke (1983). The localization of ROS in roots was done using H₂DCFDA staining following the protocol of Kaur et al. (2016) and the images were captured using fluorescent enabled system microscope (Leica DM6 B, Germany). Localization of superoxide was done using Qiao et al. (2015) using NBT stains and images were captured using stereomicroscope (Stemi 508, Zeiss, Jena, Germany) with an Axicam 105 colour camera (Zeiss, Jena, Germany).

### Estimation of Non-enzymatic Antioxidants and Metabolites

The levels of glutathione (GSH) and ascorbate (AsA) were measured using the modified Moron et al. (1979) and Law et al. (1983) methods. The GSH content in the samples was determined using L-ascorbic acid and reduced glutathione as the standard. The protocol of Bates et al. (1973) was utilized to determine proline content, and L-proline was employed as the standard. The extraction and measurement of flavonoid content was done according to the protocol of Mirecki and Teramura (1984), and Mancinelli et al. (1975) to extract and quantify the anthocyanins content.

### Quantification of Essential Elements and Translocation of As III

The tissues were harvested, rinsed with de-ionized (DI) water, and dried in an oven at 75 °C for 72 h. According to Ma et al. (2015), 0.2 g dried ground tissue samples of root and shoot were digested. Inductively coupled plasma optical emission spectrometry (ICP-OES, iCAP 6500, Thermo Fisher Scientific, Texas, USA) was used to quantify sodium (Na), potassium (K), zinc (Zn), and other selected elements. Standard reference materials (NIST-SRF 1570a and 1547, Metuchen, NJ) were prepared and analyzed using the same procedure to validate the measurements. For the calibration, both blank samples (devoid of any plant tissues) and spiked samples at varying concentrations were utilized. An internal standard of Yttrium (Y) was employed.

### Statistical Analysis

Multiple variables were statistically analyzed using Duncan's multiple range tests at a probability level of 5%. The one-way ANOVA was performed using SPSS 16.0, SPSS Inc., Chicago, USA. The data depicts the mean and ±standard error of three independent experiments with three replicates each and student t-test was also carried out at a probability level of 5%.

### Drought Stress at Maturity in Pot Study

A long-term polyhouse pot experiment (~125 days) was conducted to determine the effect of seed priming on yield under abiotic stress conditions. The sterilized primed and unprimed seeds were allowed to germinate and grow in pots filled with a standard potting mixture of soil, peat, and perlite (2:1:1) to ensure optimal air, water, and nutrient circulation. Nutrients, including urea and NPK fertilizers, were applied periodically in solution form through the irrigation systems periodically. Seedlings were thinned at 14 days to maintain three uniform plants per pot for each treatment. Plants were allowed to grow under optimal conditions of polyhouse (26±4 °C, relative humidity 60±2%, 12 h photoperiod, and PPFD 28-600 μmol m⁻² s⁻¹) until the late vegetative phase (55 days). Subsequently, abiotic stress treatments were administered for 15 days between the 55ª and 70^{th} days.

The plants were subjected to drought stress by withholding water until the soil moisture level reached around 50% of field capacity, relative to the control group and was maintained during the whole stress period. Following stress exposure, plants were re-watered and allowed to grow under normal optimal conditions until maturity. Salinity stress was induced by incrementally elevating the administration of NaCl solution (100 mM) via the tray irrigation method to prevent a possible osmotic shock. Key physiological gas exchange parameters were recorded around 95-day to evaluate the combined effects of priming and stress treatments. At harvest (~125 day), yield-related traits were measured.

Having thus described exemplary embodiments of the present disclosure, it should be noted by those skilled in the art that the within disclosures are exemplary only and that various other alternatives, adaptations and modifications may be made within the scope of the present disclosure. Accordingly, the present disclosure is not limited to the above preferred embodiments and examples but is only limited by the following claims.

What is claimed is:

1. A composition comprising:
a seed; and,
a graphitic carbon nitride nanosheet coating applied to the seed.

2. The composition of claim 1 wherein the graphitic carbon nitride nanosheet is doped with at least one positive ion.

3. The composition of claim 2 wherein the at least one positive ion is at least one selected from the group of: Zn, Ca, Cu, Fe, B, Mn, Mo, Ni, and S.

4. A method comprising:
loading urea into a crucible;
optionally adding a metal precursor;
sealing and heating the crucible to a temperature of 550 °C for 2 h to obtain g-C₃N₄ powder or optionally a metal-doped g-C₃N₄ powder;
washing the obtained powder with excess deionized water and ethanol; and,
vacuum drying the powder.

5. The method of claim 4 further comprising:
dissolving the powder in deionized water forming a solution;
adding surface-sterilized seeds to the solution; and,
agitating the seed-solution mixture for a minimum of 12 h.

6. The method of claim 4 wherein the metal precursor is added at 05 wt %

7. The method of claim 4 wherein the metal precursor is [Zn(NO₃)₂·6H₂O].

8. The method of claim 4 wherein the metal precursor supplies at least one element selected from the group of: Zn, Ca, Cu, Fe, B, Mn, Mo, Ni, and S.

9. The method of claim 5 further comprising:
removing the seeds from the seed-solution mixture;
drying the seeds; and,
storing or planting the primed seeds.

10. A seed primed with a graphitic carbon nitride nanosheet coating.

11. The seed of claim 10 wherein the graphitic carbon nitride nanosheet coating is further doped with at least one metal.

12. The seed of claim 10 wherein the seed is a crop plant seed.

13. The seed of claim 10 wherein the graphitic carbon nitride nanosheet coating is obtained via the method of claim 5.

14. The seed of claim 10 provided with one or more additional coatings.

15. The seed of claim 14 wherein the one or more additional coatings are at least one selected from the group of: a moisture control coating, an antifungal coating, an insecticidal coating, and a fertilizer coating.

16. A method of increasing abiotic stress tolerance in a crop plant and increasing productivity of a crop plant under drought stress or salinity stress, comprising:
contacting a seed with a dispersion comprising graphitic carbon nitride nanosheets to form a graphitic carbon nitride nanosheet coating on a plant seed seed;
planting the seed; and
growing a plant from the seed, wherein the graphitic carbon nitride nanosheet coating increases tolerance of the rice plant to drought stress, salinity stress, or toxic metal stress and increases productivity of the rice plant under drought stress or salinity stress relative to a plant grown from an unprimed seed.

17. A method of biofortifying a crop plant, comprising:
contacting a seed with a dispersion comprising graphitic carbon nitride nanosheets doped with one or more micronutrient elements selected from Zn, Fe, Ca, Cu, B, Mn, Mo, Ni, and S to form a graphitic carbon nitride nanosheet coating on the crop plant seed;
planting the seed; and,
growing a plant from the seed, wherein harvested plant material from the plant has increased accumulation of one or more nutrient elements relative to harvested plant material from a plant grown from an unprimed seed.
